(19) United States
(12) Patent Application Publication
(10) Pub. No.: US 2014/0155139 A1
(43) Pub. Date: Jun. 5, 2014

(54) Reverse marketing and gaming

(71) Applicants: Jean-Francois Nicolas, Marly-Le-Roi (FR); Jean-Luc Cadranel, Montpellier (FR)

(72) Inventors: Jean-Francois Nicolas, Marly-Le-Roi (FR); Jean-Luc Cadranel, Montpellier (FR)

(21) Appl. No.: 13/999,095

(22) Filed: Jan. 13, 2014

Related U.S. Application Data
(63) Continuation-in-part of application No. 13/374,699, filed on Jan. 9, 2012, now Pat. No. 8,662,977.
Application No. 13/374,699 is a continuation-in-part of application No. 12/003,394, filed on Dec. 26, 2007, now Pat. No. 8,118,654.
(60) Provisional application No. 60/877,101, filed on Dec. 26, 2006.

(51) Int. Cl. G06Q 30/02; G07F 17/32

(52) U.S. Cl. CPC G06Q 30/0207; G07F 17/3255
USPC 463/25

(57) ABSTRACT

The method consists in a new way of distributing advantages based on a new category of online game.

### CROSS-REFERENCE TO RELATED APPLICATIONS

This application is a continuation in part of, and claims priority to and the benefit of, U.S. patent application Ser. No. 13/374,699, filed on Jan. 9, 2012, which is a continuation in part of, and claims priority to and the benefit of, U.S. patent application Ser. No. 12/003,394, filed on Dec. 26, 2007, which issued as U.S. Pat. No. 8,118,654 on Feb. 21, 2012, which is a non-provisional of, and claims priority to and the benefit of, U.S. Provisional Application 60/877,101, filed Dec. 26, 2006, now expired, the entire contents of each of which are incorporated herein by reference.

### STATEMENT REGARDING FEDERALLY SPONSORED RESEARCH OR DEVELOPMENT

Not applicable.

### REFERENCE TO SEQUENCE LISTING, A TABLE, OR A COMPUTER LISTING COMPACT DISK APPENDIX

Not applicable.

### BACKGROUND OF THE INVENTION

The traditional way of making a promotional offer is to determine an advantage to offer and then to inform the prospects or customers or prospects of the advantage. The advantage can consist in any advantage, like rebates, additional content, coupons, and all types of benefits a man of the art can think of. An appropriate communication is elaborated, including information through advertising, packaging, point-of-sale promotion or communication, and all types of communication a man of the art can think of. Generally, the promotional operation is associated with a product. Generally, the promotional operation is associated with a period of validity of the offer. During the period of validity, for example between a first date and a second later date, the promotional offer is valid. Generally, the promotional offer is associate with a maximum number of offers. For example, a quantity of X products is produced with a special packaging indicating what the offer is and the period of validity of the offer, and additional communication is done through advertising and point-of-sale promotion or communication.

The Internet, mobile phones, and the mobile Internet enable promotional offers to be more reactive and interactive. The Internet, mobile phones, and the mobile Internet enable promotional offers to be more closely associated or integrated with online games. Different methods are disclosed hereafter. Disclosed methods are useful for companies using promotional offers. They enable these companies to provide more sustainable promotional offers: cheaper, lasting longer, more funny for the user, and more targeted to potential buyers.

### BRIEF SUMMARY OF THE INVENTION

The method consists in combining the hereunder disclosed particular methods, either in totality or in part.

A particular method consists in distributing the advantages of the promotional offer in a plurality of periods. Instead of having, for example, 1000 advantages to distribute with one validity period of, for example, 20 days, the validity period can be split into 20, and considered as a plurality of 20 periods.

A particular method consists in needing a request from a prospect or customer prior to determining if an advantage is available to the public or prospect. In one embodiment, the user determines a category in order to know if an advantage associated with the category is available. For example, the user uses a browser. For example, the user uses a screentouch. In one embodiment, the user is located in a shop and sends a request to know if an advantage is associated with a product. For example, the user uses his mobile phone or a device located in the shop to send the request. For example, the product code can be used as a basis for the request.

A particular method consists in associating a method of distribution of advantages with fidelity points. For example, the user can get fidelity points, and these fidelity points are used as a basis to allocate the advantages among the users.

A particular method consists in associating a method of distribution of advantages with a game. For example, the user can win points in associated games, and these points are used as a basis to allocate the advantages among the users.

In one embodiment, the four elements described are associated: one: a repartition of the advantages of the promotional offer in a plurality of periods; two: a prior requirement of the mention of a category of interests by the user before any display of the available advantages; three: a distribution of advantages based on fidelity points; four: a game to distribute additional points.

A particular embodiment consists in spreading out the advantages issued from the promotional offer in a plurality of periods. This could make the promotional effort less costly and more sustainable in a long run. For instance, a distributor instead of proposing a 30% rebate on each sale of 1000 cameras in 30 days maximum, could propose a 30% rebate on each sale of 10 cameras every day during 30 days. Of course, the objective is not the same. In the first case, the objective would be to get rid of a stock of the former models of cameras in order to give place to the new models. In the second case, the objective could be to advertise on the arrival of the new models of cameras or just to catch the attention of potential customers.

A particular embodiment consists in requiring a prior mention of the category of interests by the user before any display of the available advantages. This could enable a web site to identify the potential customers presently ready to buy a particular product or service. Then, they could be individually addressed by an adapted advertising or by personalized promotional offers concerning the chosen category. For instance, if a visitor comes in a web site where immediately he can see all the products or services presenting promotional advantages, he will go out if he does not found what he is looking for and then he will be lost for the site. Otherwise, if he is bound from the start to precise his category of interests, for instance cameras, and if no advantage is at the time available on cameras, he could be later informed by email of any advantage proposed on cameras.

A particular embodiment consists in a distribution of advantages based on fidelity points. Usually fidelity points are acquired by previous sales. Here fidelity points are intended to advantage the more constant users. Thus they could be quite sure to find attractive advantages for their prospective purchases. For instance, fidelity points would not favor users who several times bought products like video products and not even those who previously got any promotional advantage, but they would favor users who simply made frequent requests of categories or regularly participated to a game which may be proposed in association (see below).

A particular embodiment consists in using a game to distribute points. Normally games are used for fun or for the distribution of valuable prizes or for the classification of competitors. Here there is just a distribution of at least non valuable points: at least no fun, at least no direct value, at least no ranking of skills. This embodiment targets mainly the new users, who can like that win additional fidelity points and keep a chance to get the advantage they look for, even when coming for the first time. It may be any kind of game: a game of skill, a game of chance, a game with a mix of skill and chance, a game of knowledge, a game with a mix of chance and knowledge, skill and knowledge or skill, chance and knowledge. In particular, it may be a forecasting game like the game described in the U.S. Pat. No. 8,118,654. It may be also the game described in our previous disclosure in application Ser. No. 13/374,699 and in the twin disclosure with its specific business model.

### BRIEF DESCRIPTION OF THE SEVERAL VIEWS OF THE DRAWING

Not applicable

### DETAILED DESCRIPTION OF THE INVENTION

### Detailed Description—Part One

A method is provided, said method 1, comprising: causing a processor to execute a plurality of instructions stored on at least one memory device to: (a) enable at least one player to have an account wherein: (i) the account is associated with the at least one player, (ii) the at least one player is enabled to accumulate points on the account, and (iii) the at least one player is granted a first number of points when the account is created, wherein: (iiia) the first number of points is associated with the at least one player, (iiib) the first number of points is either (iiibi) equal to zero, or (iiibii) different from zero, and (iiic) the first number of points is accumulated on the account, (b) determine at least one game, including: (i) determine a first plurality of periods wherein the first plurality of periods is associated with the at least one game, (ii) enable the at least one player to have at least one participation in the at least one game for at least one period of the first plurality of periods, said the at least one participation, wherein: (iia) the at least one participation is associated with: (iiai) the at least one player, (iiaii) the at least one game, (iiaiii) the at least one period of the first plurality of periods, and (iiaiv) a first wager wherein the first wager is either (iiaiva) equal to zero, or (iiaivb) greater than zero, and (iib) the at least one player is granted a second number of points if the at least one participation is received from the at least one player, wherein: (iibi) the second number of points is associated with the at least one player, (iibii) the second number of points is either (iibiia) equal to zero, or (iibiib) different from zero, and (iibiii) the second number of points is accumulated on the account, and (iii) if the at least one participation is received from the at least one player, determine if the at least one participation is associated with at least one prize, wherein: (iiia) the at least one prize comprise a third number of points, wherein: (iiiai) the third number of points is associated with the at least one player, (iiiaii) the third number of points is either (iiiaiia) equal to zero, or (iiiaiib) different from zero, and (iiiaiii) the third number of points is accumulated on the account, and (iiib) if the determination is that the at least one prize is associated with the at least one participation, provide the at least one prize to the at least one player, (c) determine a second plurality of periods, (d) determine at least one category, (e) determine at least one promotional offer, including: (i) include in each of the at least one promotional offer a plurality of advantages to be offered, said the plurality of advantages, and (ii) for each of the at least one promotional offer: (iia) associate each advantage of the plurality of advantages with the at least one promotional offer, (iib) associate each advantage of the plurality of advantages with the same at least one of the at least one category, and (iic) associate the plurality of advantages with the second plurality of periods, wherein: (iici) each advantage of the plurality of advantages is associated with at least one period of the second plurality of periods, and (iicii) at least two periods of the second plurality of periods are associated with at least one advantage of the plurality of advantages, and (f) for at least one period of the second plurality of periods: (i) enable the at least one player to make at least one request wherein: (ia) the at least one request is associated with at least one of the at least one category, (ib) the at least one request is associated with the at least one period of the plurality of periods, (ic) the at least one request is associated with a fourth number of points, wherein (ici) the fourth number of points is either (icia) equal to zero, or (icib) different from zero, and (icii) the fourth number of points is accumulated on the account, and (id) the at least one request is associated with a first payment wherein the first payment is either (idi) equal to zero, or (idii) greater than zero, said the request, (ii) make a first determination, wherein the first determination is to determine if the request is received from the at least one player, (iii) if the first determination is true, make a second determination wherein the second determination is to determine if at least one advantage of the plurality of advantages included in each of the at least one promotional offer is: (iiia) associated with the at least one period of the plurality of periods which is associated with the request, and (iiib) associated with the at least one of the at least one category which is associated with the request, and (iv) if the second determination is true: (iva) determine the at least one advantage of the plurality of advantages included in each of the at least one promotional offer which is associated with: (ivai) the at least one period of the plurality of periods which is associated with the request, and (ivaii) the at least one of the at least one category which is associated with the request, said the at least one available advantage, (ivb) determine a number of the points accumulated on the account wherein: (ivbi) the number of the points accumulated on the account is associated with the at least one player, and (ivbii) the number of the points accumulated on the account is based at least on: (ivbiia) the first number of points, (ivbiib) the second number of points, (ivbiic) the third number of points, and (ivbiid) the fourth number of points, (ivc) make a third determination wherein the third determination is to determine if the request is associated with the at least one available advantage based at least on the number of the points accumulated on the account, and (ivd) if the third determination is true, provide the at least one available advantage to the at least one player and either (ivdi) maintain the number of the points accumulated on the account, or (ivdii) change the number of the points accumulated on the account to an other number of the points accumulated on the account.

A method is provided, said method 2, which is the method 1 wherein at least one of: (i) the at least one game is a game of pure chance, (ii) the at least one game has a part of chance, (iii) the at least one game is a game of mixed chance and skill, (iv) the at least one game is a lottery game, (v) the at least one game is a forecasting game, (vi) the at least one game is a financial game, (vii) the at least one game is a financial forecasting game, (viii) the at least one game is a betting game, (ix) the at least one game is a sports game, (x) the at least one game is a game with questions, (xi) the at least one game is a quizz, (xii) the at least game is a skill game, (xiii) the at least game has a part of skill, (xiv) the at least game is a game of knowledge, and (xv) the at least game has a part of knowledge.

A method is provided, said method 3, which is the method 1 wherein at least one of: (a) the first plurality of periods and the second plurality of periods are the same or different, (b) at least one period of the first plurality of periods and at least one the second plurality of periods are the same or different, (c) the at least one game and the at least one promotional offer can be accessed on the same or different devices, (d) the at least one game and the at least one promotional offer can be accessed at a same or different times, and (e) the at least one game or the at least one promotional offer can be accessed with a touchscreen.

A method is provided, said method 4, which is the method 1 further comprising at least one of: (a) the third determination is based at least on a ranking of the at least one player, wherein the ranking of the at least one player is based at least on the number of the points accumulated on the account, (b) the third determination is based at least on a scoring of the at least one player, wherein the scoring of the at least one player is based at least on the number of the points accumulated on the account, (c) the number of the points accumulated on the account associated with the at least one player can be transferred to another different account associated with another different at least one player either (i) in part, or (ii) in totality, and (d) change the third determination to be based at least on a chosen number of points, wherein the chosen number of points is (i) lower than the number of the points accumulated on the account, and (ii) determined by the at least one player.

A method is provided, said method 5, which is the method 1 further comprising: causing the processor to execute a plurality of instructions stored on at least one memory device to: (a) receive the at least one request from the at least one player, (b) receive at least one second request from the at least one player, wherein the at least one second request from the at least one user is: (i) associated with a second at least one of the at least one category, wherein the second at least one of the at least one category is either (ia) the same at least one of the at least one category which is associated with the request, or (ib) a different at least one of the at least one category from the at least one of the at least one category which is associated with the request, (ii) associated with a second at least one period of the second plurality of periods, wherein the second at least one period of the second plurality of periods is either (iia) the same at least one period of the second plurality of periods which is associated with the request, or (iib) a different at least one period of the second plurality of periods from the at least one period of the second plurality of periods which is associated with the request, (iii) associated with a fifth number of points, wherein the fifth number of points is either (iiia) equal to zero, or (iiib) different from zero, and (iv) associated with a second payment wherein the second payment is either (iva) equal to zero, or (ivb) greater than zero, said the second request, (c) make a fifth determination wherein the fifth determination is to determine if a second at least one advantage of the second plurality of advantages included in each of the at least one promotional offer is: (ci) associated with the second at least one period of the second plurality of periods associated with the second request, and (cii) associated with the second at least one of the at least one category associated with the second request, and (d) if the fifth determination is true: (i) determine the second at least one advantage of the plurality of advantages included in each of the at least one promotional offer which is associated with: (ia) the second at least one period of the second plurality of periods associated with the second request, and (ib) the second at least one of the at least one category associated with the second request, said the second at least one available advantage, (ii) determine a second number of the points accumulated on the account wherein: (iia) the second number of the points accumulated on the account is associated with the at least one player, and (iib) the second number of the points accumulated on the account is based at least on: (iibi) either (iibia) the number of the points, or (iibib) the other number of the points, and (iibii) the fifth number of points, (iii) make a sixth determination wherein the sixth determination is to determine if the second request is associated with the second at least one available advantage based at least on the second number of the points accumulated on the account, and (iv) if the sixth determination is true, provide the second at least one available advantage to the at least one player and either (iva) maintain the second number of the points accumulated on the account, or (ivb) change the second number of the points accumulated on the account to an other second number of the points accumulated on the account.

A method is provided, said method 6, which is the method 1 further comprising: causing the processor to execute a plurality of instructions stored on at least one memory device to: (a) determine a third plurality of periods wherein the third plurality of periods and the first plurality of periods are either (i) the same, or (ii) different, (b) determine at least one second game, wherein: (i) the at least one game is associated with the third plurality of periods, and (ii) the at least one second game and the at least one game are either (i) the same, or (ii) different, (c) enable the at least one player to have at least one second participation from the at least one player in the at least one second game for at least one second period of the third plurality of periods, wherein: (i) the at least one period of the first plurality of periods for which the at least one participation in the at least one game is received from the at least one player and the at least one second period of the third plurality of periods for which the at least one second participation is received from the at least one player in the at least one second game are either (ia) the same, or (ib) different, and (ii) the at least one game wherein the at least one participation is received from the at least one player for the at least one period of the first plurality of periods and the at least one second game wherein the at least one second participation is received from the at least one player for the at least second period of the third plurality of periods are either (iia) the same, or (iib) different, (iii) the at least one second participation is associated with: (iiia) the at least one player; (iiib) the at least one second game, (iiic) the at least one second period of the third plurality of periods, and (iiid) a second wager wherein the second wager is either (iiidi) equal to zero, or (iiidii) greater than zero, (iv) the at least one player is granted a fifth number of points if the at least one second participation is received from the at least one player, wherein: (iva) the fifth number of points is associated with the at least one player, (ivb) the fifth number of points is either (ivbi) equal to zero, or (ivbii) different from zero, and (ivc) the fifth number of points is accumulated on the account, and (v) if the at least one second participation is received from the at least one player, determine if the at least one second participation is associated with at least one second prize, wherein: (va) the at least one second prize comprise a sixth number of points, wherein: (vai) the sixth number of points is associated with the at least one player, (vaii) the sixth number of points is either (vaiia) equal to zero, or (vaiib) different from zero, and (vaiii) the sixth number of points is accumulated on the account, and (vb) if the determination is that the at least one second prize is associated with the at least one second participation, provide the at least one second prize to the at least one player, and (d) change the determination of the number of the points accumulated on the account to be based at least on: (i) the first number of points, (ii) the second number of points, (iii) the third number of points, (iv) the fourth number of points, (v) the fifth number of points, and (vi) the sixth number of points.

A method is provided, said method 7, which is the method 5 wherein at least one of: (a) the fourth number of points associated with the at least one request from the at least one player and the fifth number of points associated with the at least one second request from the at least one player are the same or different, (b) the fourth number of points associated with the at least one request from the at least one player and the fifth number of points associated with the at least one second request from the at least one player are the same or different wherein: (i) the at least one period of the second plurality of periods which is associated with the at least one request from the at least one player, and (ii) the second at least one period of the second plurality of periods which is associated with the at least one second request from the at least one player, are the same or different, (c) the fourth number of points associated with the at least one request from the at least one player and the fifth number of points associated with a at least one second request from the at least one player are the same or different wherein: (i) the at least one category which is associated with at least one request from the at least one player, and (ii) the second at least one category which is associated with the at least one second request from the at least one player, are the same or different, and (d) the fifth number of points associated with the at least one second request from the at least one player is greater than the fourth number of points associated with the at least one request from the at least one player wherein: the second at least one period of the second plurality of periods which is associated with the at least one second request from the at least one player is later than the at least one period of the second plurality of periods which is associated with the at least one request from the at least one player.

A method is provided, said method 8, which is the method 6 wherein at least one of: (a) the second number of points associated with the at least one participation from the at least one player and the fifth number of points associated with the at least one second participation from the at least one player are the same or different, (b) the third number of points associated with the at least one participation from the at least one player and the sixth number of points associated with the at least one second participation from the at least one player are the same or different, (c) the second number of points associated with the at least one participation from the at least one player and the fifth number of points associated with the at least one second participation from the at least one player are the same or different, wherein: (i) the at least one period of the first plurality of periods which is associated with the at least one participation from the at least one player, and (ii) the at least one period of the third plurality of periods which is associated with the at least one second participation from the at least one player, are the same or different, (d) the second number of points associated with the at least one participation from the at least one player and the fifth number of points associated with the at least one second participation from the at least one player are the same or different, wherein: (i) the at least one game which is associated with the at least one participation from the at least one player, and (ii) the at least one second game which is associated with the at least one second participation from the at least one player, are the same or different, (e) the third number of points associated with the at least one participation from the at least one player and the sixth number of points associated with the at least one second participation from the at least one player are the same or different, wherein: (i) the at least one period of the first plurality of periods which is associated with the at least one participation from the at least one player, and (ii) the at least one period of the third plurality of periods which is associated with the at least one second participation from the at least one player, are the same or different, and (f) the third number of points associated with the at least one participation from the at least one player and the sixth number of points associated with the at least one second participation from the at least one player are the same or different, wherein: (i) the at least one game which is associated with the at least one participation from the at least one player, and (ii) the at least one second game which is associated with the at least one second participation from the at least one player, are the same or different.

A method is provided, said method 9, which is the method 1 wherein at least one of: (a) at least one of: (I) during the second plurality of periods the at least one player is provided, (II) during each period of the second plurality of periods the at least one player is provided, (III) during at least one of the each period of the second plurality of periods the at least one player is provided, (IV) during each period of the second plurality of periods the request is associated, and (V) during at least one of the each period of the second plurality of periods the request is associated, with at least one of: (i) zero advantage, (ii) one advantage, and (iii) more than one advantage, (b) at least one of: (I) during the second plurality of periods the plurality of advantages in at least one of the at least one promotional offer to be offered, (II) during the second plurality of periods the plurality of advantages in each of the at least one promotional offer to be offered, (III) during each period of the second plurality of periods the at least one available advantage, and (IV) during at least one of the each period of the second plurality of periods the at least one available advantage, is at least one of: (i) totally attributed, (ii) partially attributed, and (iii) with zero attribution, (c) each period of the second plurality of periods has a same or different duration, and (d) at least two of the each period of the second plurality of periods have a same or different duration.

A method is provided, said method 10, which is the method 1 wherein at least one of: (a) the at least one category is at least one of: (i) a product, (ii) a service, (iii) a shop, (iv) a website, (v) a category of products, (vi) a category of services, (vii) a category of shops, (viii) a category of websites, (ix) including at least one product, (x) including at least one service, (xi) including at least one shop, (xii) including at least one website, (xiii) a plurality of products, (xiv) a plurality of services, (xv) a plurality of shops, and (xvi) a plurality of websites, (b) at least one of: (I) each advantage of the plurality of advantages, (II) at least one of the each advantage of the plurality of advantages, (III) each of the at least one promotional offer, and (IV) at least one of the at least one promotional offer, is at least one of: (i) associated with a product, (ii) associated with a service, (iii) associated with a shop, (iv) associated with a website, (v) associated with a category of products, (vi) associated with a category of services, (vii) associated with a category of shops, (viii) associated with a category of websites, (ix) associated with a plurality of products, (x) associated with a plurality of services, (xi) associated with a plurality of shops, and (xii) associated with a plurality of websites, (c) each advantage of the plurality of advantages is the same or different, and (d) at least two of the each advantage of the plurality of advantages are the same or different.

A method is provided, said method 11, which is the method 1 wherein at least one of: (a) at least one of: (i) the first determination, (ii) the second determination, and (iii) the third determination, is true or false, (b) the second or third determination is an instant determination, (c) the third determination is based at least on at least one of: (i) a ranking, (ii) random, (iii) skill, (iv) skill with a part of chance, (v) time, (vi) the moment of the request, (vii) points, (viii) a number of points, (ix) fidelity, (x) individual criteria, (xi) name, (xii) birth, (xiii) money, (xiv) fortune, (xv) revenue, (xvi) an event, (xvii) the outcome of an event, (xviii) knowledge, and (xix) a game, (d) the third determination is at least one of: (i) done at the end of the at least one period of the plurality of periods, (ii) done during the at least one period of the plurality of periods, and (iii) done at the end of the plurality of periods, (e) at least one of: (I) the third determination is based at least on a number of points, (II) the third determination is based at least on the moment of the request, (III) the third determination is done at the end of the at least one period of the plurality of periods, (IV) the third determination is done during the at least one period of the plurality of periods, (V) the third determination is done at the end of the plurality of periods, (VI) the third determination is based at least on a ranking, and (VII) the third determination is based at least on time, and at least one of: (i) the at least one player is provided with zero available advantage, (ii) the at least one player is provided with one available advantage, (iii) the at least one player is provided with more than one available advantage, (iv) zero available advantage is provided, (v) one available advantage is provided, (vi) more than one available advantage is provided, and (vii) at least two players are provided with at least one available advantage, and (f) the third determination is based at least on at least one number of points wherein the calculation of the at least one number of points comprise at least one of: (i) points granted in at least one game, (ii) points granted for fidelity, (iii) points associated with the at least one request, and (iv) points associated with the at least one request and points granted in at least one game.

A method is provided, said method 12, which is the method 1 further comprising at least one of: (a) the at least one promotional offer is associated with at least one game, wherein the third determination to determine if the request is associated with the at least one available advantage is based at least on the at least one game, and wherein at least one of: (i) the at least one game is a game of pure chance, (ii) the at least one game has a part of chance, (iii) the at least one game is a game of mixed chance and skill, (iv) the at least one game is a lottery game, (v) the at least one game is a forecasting game, (vi) the at least one game is a financial game, (vii) the at least one game is a financial forecasting game, (viii) the at least one game is a betting game, (ix) the at least one game is a sports game, (x) the at least one game is a game with questions, and (xi) the at least one game is a quizz, (xii) the at least game is a skill game, (xiii) the at least game has a part of skill, (xiv) the at least game is a game of knowledge, and (xv) the at least game has a part of knowledge, and (b) the at least one promotional offer is associated with at least one event, wherein the third determination to determine if the request is associated with the at least one available advantage is based at least on the outcome of the at least one event, and the at least one event is at least one of: (i) an event associated with the at least one player, (ii) an event associated with a shop, (iii) an event associated with money, (iv) an event associated with a number, (v) an event associated with a result, and (vi) an event associated with sports.

A method is provided, said method 13, which is the method 1 further comprising at least one of: (a) receive at least one second payment from at least one other source than the at least one player, wherein the at least one second payment is associated with: (i) advertising, (ii) selling data, (iii) sponsoring, (iv) selling a service, (v) selling a product, (vi) at least one device, (vii) at least one mobile device, and (viii) at least one investor, (b) build databases with collected data, (c) sell data associated with the at least one player, (d) after the second determination use links to websites or mobile sites, and (e) use links to websites or mobile sites.

A method is provided, said method 14, which is the method 1 wherein the at least one player is located in a determined shop when he makes the request and at least one of: (a) the at least one category comprises items sold in the determined shop, (b) the at least one category is at least one of: (i) a product, (ii) a service, (iii) a shop, (iv) a website, (v) a category of products, (vi) a category of services, (vii) a category of shops, (viii) a category of websites, (ix) including at least one product, (x) including at least one service, (xi) including at least one shop, (xii) including at least one website, (xiii) a plurality of products, (xiv) a plurality of services, (xv) a plurality of shops, and (xvi) a plurality of websites, and (c) at least one of: (I) each advantage of the plurality of advantages, (II) at least one of the each advantage of the plurality of advantages, (III) each of the at least one promotional offer, and (IV) at least one of the at least one promotional offer, is at least one of: (i) associated with a product, (ii) associated with a service, (iii) associated with a shop, (iv) associated with a website, (v) associated with a category of products, (vi) associated with a category of services, (vii) associated with a category of shops, (viii) associated with a category of websites, (ix) associated with a plurality of products, (x) associated with a plurality of services, (xi) associated with a plurality of shops, and (xii) associated with a plurality of websites.

A method is provided, said method 15, which is the method 1 further comprising: causing a processor to execute a plurality of instructions stored on at least one memory device to: (a) determine a time in the at least one period of the plurality of periods, and (b) if the time is determined in the at least one period of the plurality of periods: (i) cancel the third determination, (ii) if the second determination is true, make a fourth determination wherein the fourth determination is to determine if (iia) the request is associated with the at least one available advantage, and (iib) the request is received after the determined time in the at least one period of the plurality of periods, and (iii) if the fourth determination is true, provide the at least one available advantage to the at least one player.

A method is provided, said method 16, which is the method 1 further comprising: (a) determine at least one supplier wherein the at least one supplier is associate with the at least one category, and (b) contact at least one of each of the at least one supplier associated with the at least one category wherein at least one of: (i) at least one of each of the at least one supplier associated with the at least one category is invited to make a business offer to the at least one player, (ii) at least one of each of the at least one supplier associated with the at least one category is invited to make a business offer to the at least one player wherein the business offer to the at least one player is associated with a quantity, (iii) at least one of each of the at least one supplier associated with the at least one category makes a business transaction with the at least one player, (iv) at least one of each of the at least one supplier associated with the at least one category makes a business transaction with the at least one player wherein the business transaction with the at least one player is associated with a quantity, and (v) at least one of each of the at least one supplier associated with the at least one category is invited to use collected data from the at least one player.

A method is provided, said method 17, which is the method 1 further comprising: (a) include in at least one of the at least one promotional offer a plurality of items to be sold, said the plurality of items, wherein: (i) the plurality of items is associated with the plurality of advantages included in the at least one of the at least one promotional offer, (ii) each of the items of the plurality of items is at least one of: (iia) a product, (iib) a service, (iic) a plurality of products, (iid) a plurality of services, and (iie) a plurality of products and services, (iii) each item of the plurality of items is associated with each advantage of the plurality of advantages included in the at least one of the at least one promotional offer, and (b) if the third determination is true: (i) determine if the at least one available advantage is associated with the at least one of the at least one promotional offer, (ii) if the determination is that the at least one available advantage is associated with the at least one of the at least one promotional offer, determine the item of the plurality of items which is associated with the at least one available advantage, said the promoted item, and (iii) if the at least one available advantage is provided to the at least one user, sell the promoted item to the at least one user.

The following paragraphs are disclosed for a method as well as for a system. In the following paragraphs, the reader can replace the word method by the word system. This applies to paragraphs disclosing said method 18 to said method 34. This also applies to any interpretation or use of these said methods—or systems—in the disclosure, and in other later disclosures.

For a system, the text of the method 18 will further comprise: (i) at least one input device, (ii) at least one display device, (iii) a processor, and (iv) at least one memory device which stores a plurality of instructions which when executed by the processor, cause the processor to operate with the one at least display device and the one at least input device to do what is disclosed in method 18.

A method is provided, said method 18, comprising: causing a processor to execute a plurality of instructions stored on at least one memory device to: (a) determine a plurality of periods, (b) determine at least one category, (c) determine at least one promotional offer, including: (i) include in each of the at least one promotional offer a plurality of advantages to be offered, said the plurality of advantages, and (ii) for each of the at least one promotional offer: (iia) associate each advantage of the plurality of advantages with the at least one promotional offer, (iib) associate each advantage of the plurality of advantages with the same at least one of the at least one category, and (iic) associate the plurality of advantages with the plurality of periods, wherein: (iici) each advantage of the plurality of advantages is associated with at least one period of the plurality of periods, and (iicii) at least two periods of the plurality of periods are associated with at least one advantage of the plurality of advantages, and (d) for at least one period of the plurality of periods: (i) enable the at least one user to make at least one request wherein: (ia) the at least one request is associated with at least one of the at least one category, (ib) the at least one request is associated with the at least one period of the plurality of periods, and (ic) the at least one request is associated with a first payment wherein the first payment is either (ici) equal to zero, or (icii) greater than zero, said the request, (ii) make a first determination, wherein the first determination is to determine if the request is received from the at least one user, (iii) if the first determination is true, make a second determination wherein the second determination is to determine if at least one advantage of the plurality of advantages included in each of the at least one promotional offer is: (iiia) associated with the at least one period of the plurality of periods which is associated with the request, and (iiib) associated with the at least one of the at least one category which is associated with the request, and (iv) if the second determination is true: (iva) determine the at least one advantage of the plurality of advantages included in each of the at least one promotional offer which is associated with: (ivai) the at least one period of the plurality of periods which is associated with the request, and (ivaii) the at least one of the at least one category which is associated with the request, said the at least one available advantage, (ivb) make a third determination wherein the third determination is to determine if the request is associated with the at least one available advantage, and (ivc) if the third determination is true, provide the at least one available advantage to the at least one user.

A method is provided, said method 19, which is the method 18 further comprising: causing the processor to execute a plurality of instructions stored on at least one memory device to: (a) enable at least one user to have an account wherein: (i) the account is associated with the at least one user, (ii) the at least one user is enabled to accumulate points on the account, and (iii) the at least one user is granted a first number of points when the account is created, wherein: (iiia) the first number of points is associated with the at least one user, (iiib) the first number of points is either (iiibi) equal to zero, or (iiibii) different from zero, and (iiic) the first number of points is accumulated on the account, (b) associate the at least one request with a second number of points, wherein (i) the second number of points is either (ia) equal to zero, or (ib) different from zero, and (ii) the second number of points is accumulated on the account, and (c) if the second determination is true: (i) determine a number of the points accumulated on the account wherein: (ia) the number of the points accumulated on the account is associated with the at least one user, and (ib) the number of the points accumulated on the account is based at least on: (ibi) the first number of points, and (ibii) the second number of points, (ii) base the third determination on the number of the points accumulated on the account, and (iii) if the third determination is true, either (iiia) maintain the number of the points accumulated on the account, or (iiib) change the number of the points accumulated on the account to an other number of the points accumulated on the account.

A method is provided, said method 20, which is the method 19 further comprising at least one of: (a) the third determination is based at least on a ranking of the at least one user, wherein the ranking of the at least one user is based at least on the number of the points accumulated on the account, (b) the third determination is based at least on a scoring of the at least one user, wherein the scoring of the at least one user is based at least on the number of the points accumulated on the account, (c) the number of the points accumulated on the account associated with the at least one user can be transferred to another different account associated with another different at least one user either (i) in part, or (ii) in totality, and (d) change the third determination to be based at least on a chosen number of points, wherein the chosen number of points is (i) lower than the number of the points accumulated on the account, and (ii) determined by the at least one user.

A method is provided, said method 21, which is the method 19 further comprising: causing the processor to execute a plurality of instructions stored on at least one memory device to: (a) receive the at least one request from the at least one user, (b) receive at least one second request from the at least one user, wherein the at least one second request from the at least one user is: (i) associated with a second at least one of the at least one category, wherein the second at least one of the at least one category is either (ia) the same at least one of the at least one category which is associated with the request, or (ib) a different at least one of the at least one category from the at least one of the at least one category which is associated with the request, (ii) associated with a second at least one period of the plurality of periods, wherein the second at least one period of the plurality of periods is either (iia) the same at least one period of the plurality of periods which is associated with the request, or (iib) a different at least one period of the plurality of periods from the at least one period of the plurality of periods which is associated with the request, (iii) associated with a third number of points, wherein: (iiia) the third number of points is either (iiiai) equal to zero, or (iiiaii) different from zero, and (iiib) the third number of points is accumulated on the account, and (iv) associated with a second payment wherein the second payment is either (iva) equal to zero, or (ivb) greater than zero, said the second request, (c) make a fourth determination wherein the fourth determination is to determine if a second at least one advantage of the plurality of advantages included in each of the at least one promotional offer is: (i) associated with the second at least one period of the plurality of periods associated with the second request, and (ii) associated with the second at least one of the at least one category associated with the second request, and (d) if the fourth determination is true: (i) determine the second at least one advantage of the plurality of advantages included in each of the at least one promotional offer which is associated with: (ia) the second at least one period of the plurality of periods associated with the second request, and (ib) the second at least one of the at least one category associated with the second request, said the second at least one available advantage, (ii) determine a second number of the points accumulated on the account wherein: (iia) the second number of the points accumulated on the account is associated with the at least one user, and (iib) the second number of the points accumulated on the account is based at least on: (iibi) either (iibia) the number of the points, or (iibib) the other number of the points, and (iibii) the third number of points, (iii) make a fifth determination wherein the fifth determination is to determine if the second request is associated with the second at least one available advantage based at least on the second number of the points accumulated on the account, and (iv) if the fifth determination is true, provide the second at least one available advantage to the at least one user and either (iva) maintain the second number of the points accumulated on the account, or (ivb) change the second number of the points accumulated on the account to an other second number of the points accumulated on the account.

A method is provided, said method 22, which is the method 21 wherein at least one of: (a) the second number of points associated with the at least one request from the at least one user and the third number of points associated with the at least one second request from the at least one user are the same or different, (b) the second number of points associated with the at least one request from the at least one user and the third number of points associated with the at least one second request from the at least one user are the same or different wherein: (i) the at least one period of the plurality of periods which is associated with the at least one request from the at least one user, and (ii) the second at least one period of the plurality of periods which is associated with the at least one second request from the at least one user, are the same or different, (c) the second number of points associated with the at least one request from the at least one user and the third number of points associated with a at least one second request from the at least one user are the same or different wherein: (i) the at least one category which is associated with at least one request from the at least one user, and (ii) the second at least one category which is associated with the at least one second request from the at least one user, are the same or different, and (d) the third number of points associated with the at least one second request from the at least one user is greater than the second number of points associated with the at least one request from the at least one user wherein: the second at least one period of the plurality of periods which is associated with the at least one second request from the at least one user is later than the at least one period of the plurality of periods which is associated with the at least one request from the at least one user.

A method is provided, said method 23, which is the method 19 further comprising: causing the processor to execute a plurality of instructions stored on at least one memory device to: (a) enable at least one second different user to have a second account wherein: (i) the second account is associated with the at least one second different user, (ii) the at least one second different user is enabled to accumulate points on the second account, and (iii) the at least one second different user is granted a third number of points when the second account is created, wherein: (iiia) the third number of points is associated with the at least one user, (iiib) the third number of points is either (iiibi) equal to zero, or (iiibii) different from zero, and (iiic) the third number of points is accumulated on the second account, (b) receive a second at least one request from the at least one second different user, wherein the second at least one request from the at least one second different user is: (i) associated with a second at least one of the at least one category, wherein the second at least one of the at least one category is either (ia) the same at least one of the at least one category which is associated with the request, or (ib) a different at least one of the at least one category from the at least one of the at least one category which is associated with the request, (ii) associated with a second at least one period of the plurality of periods, wherein the second at least one period of the plurality of periods is either (iia) the same at least one period of the plurality of periods which is associated with the request, or (iib) a different at least one period of the plurality of periods from the at least one period of the plurality of periods which is associated with the request, (iii) associated with a third number of points, wherein: (iiia) the third number of points is either (iiiai) equal to zero, or (iiiaii) different from zero, and (iiib) the third number of points is accumulated on the second account, and (iv) associated with a second payment wherein the second payment is either (iva) equal to zero, or (ivb) greater than zero, said the second request, (c) make a fourth determination wherein the fourth determination is to determine if a second at least one advantage of the plurality of advantages included in each of the at least one promotional offer is: (ci) associated with the second at least one period of the plurality of periods associated with the second request, and (cii) associated with the second at least one of the at least one category associated with the second request, and (d) if the fourth determination is true: (di) determine the second at least one advantage of the plurality of advantages included in each of the at least one promotional offer which is associated with: (dia) the second at least one period of the plurality of periods associated with the second request, and (dib) the second at least one of the at least one category associated with the second request, said the second at least one available advantage, (dii) determine a second number of the points accumulated on the second account wherein: (diia) the second number of the points accumulated on the second account is associated with the at least one second different user, and (diib) the second number of the points accumulated on the second account is based at least on: (diibi) either (diibia) the number of the points, or (diibib) the other number of the points, and (diibii) the third number of points, (diii) make a fifth determination wherein the fifth determination is to determine if the second request is associated with the second at least one available advantage based at least on the second number of the points accumulated on the second account, and (div) if the fifth determination is true, provide the second at least one available advantage to the at least one second different user and either (diva) maintain the second number of the points accumulated on the second account, or (divb) change the second number of the points accumulated on the second account to an other second number of the points accumulated on the second account.

A method is provided, said method 24, which is the method 23 wherein the second at least one request from the at least one second different user is: (i) associated with a second at least one of the at least one category, wherein the second at least one of the at least one category is the same at least one of the at least one category which is associated with the request, and (ii) associated with a second at least one period of the plurality of periods, wherein the second at least one period of the plurality of periods is either (iia) the same at least one period of the plurality of periods which is associated with the request, further comprising at least one of: (a) the third determination is based at least on a ranking of the at least one user and the at least one second different user, wherein the ranking of the at least one user and the at least one second different user is based at least on: (i) the number of the points accumulated on the account, and (ii) the second number of the points accumulated on the second account, and (b) the fifth determination is based at least on a ranking of the at least one user and the at least one second different user, wherein the ranking of the at least one user and the at least one second different user is based at least on: (i) the number of the points accumulated on the account, and (ii) the second number of the points accumulated on the second account.

A method is provided, said method 25, which is the method 23 wherein at least one of: (a) the second number of points associated with the at least one request from the at least one user and the third number of points associated with the second at least one request from the at least one second different user are the same or different, (b) the second number of points associated with the at least one request from the at least one user and the third number of points associated with the second at least one request from the at least one second different user are the same or different wherein: (i) the at least one period of the plurality of periods which is associated with the at least one request from the at least one user, and (ii) the second at least one period of the plurality of periods which is associated with the second at least one request from the at least one second different user are the same or different, (c) the second number of points associated with the at least one request from the at least one user and the third number of points associated with the second at least one request from the at least one second different user are the same or different wherein: (i) the at least one category which is associated with at least one request from the at least one user, and (ii) the second at least one category which is associated with the second at least one request from the at least one second different user are the same or different, and (d) the third number of points associated with the second at least one request from the at least one second different user is greater than the second number of points associated with the at least one request from the at least one user wherein: the second at least one period of the plurality of periods which is associated with the second at least one request from the at least one second different user is later than the at least one period of the plurality of periods which is associated with the at least one request from the at least one user.

A method is provided, said method 26, which is the method 18 wherein at least one of: (a) at least one of: (I) during the plurality of periods the at least one user is provided, (II) during each period of the plurality of periods the at least one user is provided, (III) during at least one of the each period of the plurality of periods the at least one user is provided, (IV) during each period of the plurality of periods the request is associated, and (V) during at least one of the each period of the plurality of periods the request is associated, with at least one of: (i) zero advantage, (ii) one advantage, and (iii) more than one advantage, (b) at least one of: (I) during the plurality of periods the plurality of advantages in at least one of the at least one promotional offer to be offered, (II) during the plurality of periods the plurality of advantages in each of the at least one promotional offer to be offered, (III) during each period of the plurality of periods the at least one available advantage, and (IV) during at least one of the each period of the plurality of periods the at least one available advantage, is at least one of: (i) totally attributed, (ii) partially attributed, and (iii) with zero attribution, (c) each period of the plurality of periods has a same or different duration, and (d) at least two of the each period of the plurality of periods have a same or different duration.

A method is provided, said method 27, which is the method 18 wherein at least one of: (a) the at least one category is at least one of: (i) a product, (ii) a service, (iii) a shop, (iv) a website, (v) a category of products, (vi) a category of services, (vii) a category of shops, (viii) a category of websites, (ix) including at least one product, (x) including at least one service, (xi) including at least one shop, (xii) including at least one website, (xiii) a plurality of products, (xiv) a plurality of services, (xv) a plurality of shops, and (xvi) a plurality of websites, (b) at least one of: (I) each advantage of the plurality of advantages, (II) at least one of the each advantage of the plurality of advantages, (III) each of the at least one promotional offer, and (IV) at least one of the at least one promotional offer, is at least one of: (i) associated with a product, (ii) associated with a service, (iii) associated with a shop, (iv) associated with a website, (v) associated with a category of products, (vi) associated with a category of services, (vii) associated with a category of shops, (viii) associated with a category of websites, (ix) associated with a plurality of products, (x) associated with a plurality of services, (xi) associated with a plurality of shops, and (xii) associated with a plurality of websites, (c) each advantage of the plurality of advantages is the same or different, and (d) at least two of the each advantage of the plurality of advantages are the same or different.

A method is provided, said method 28, which is the method 18 wherein at least one of: (a) at least one of: (i) the first determination, (ii) the second determination, and (iii) the third determination, is true or false, (b) the second or third determination is an instant determination, (c) the third determination is based at least on at least one of: (i) a ranking, (ii) random, (iii) skill, (iv) skill with a part of chance, (v) time, (vi) the moment of the request, (vii) points, (viii) a number of points, (ix) fidelity, (x) individual criteria, (xi) name, (xii) birth, (xiii) money, (xiv) fortune, (xv) revenue, (xvi) an event, (xvii) the outcome of an event, and (xviii) a game, (d) the third determination is at least one of: (i) done at the end of the at least one period of the plurality of periods, (ii) done during the at least one period of the plurality of periods, and (iii) done at the end of the plurality of periods, (e) at least one of: (I) the third determination is based at least on a number of points, (II) the third determination is based at least on the moment of the request, (III) the third determination is done at the end of the at least one period of the plurality of periods, (IV) the third determination is done during the at least one period of the plurality of periods, (V) the third determination is done at the end of the plurality of periods, (VI) the third determination is based at least on a ranking, and (VII) the third determination is based at least on time, and at least one of: (i) the at least one user is provided with zero available advantage, (ii) the at least one user is provided with one available advantage, (iii) the at least one user is provided with more than one available advantage, (iv) zero available advantage is provided, (v) one available advantage is provided, (vi) more than one available advantage is provided, and (vii) at least two users are provided with at least one available advantage, and (f) the third determination is based at least on at least one number of points wherein the calculation of the at least one number of points comprise at least one of: (i) points granted in at least one game, (ii) points granted for fidelity, (iii) points associated with the at least one request, and (iv) points associated with the at least one request and points granted in at least one game.

A method is provided, said method 29, which is the method 18 further comprising at least one of: (a) the at least one promotional offer is associated with at least one game, wherein the third determination to determine if the request is associated with the at least one available advantage is based at least on the at least one game, and wherein at least one of: (i) the at least one game is a game of pure chance, (ii) the at least one game has a part of chance, (iii) the at least one game is a game of mixed chance and skill, (iv) the at least one game is a lottery game, (v) the at least one game is a forecasting game, (vi) the at least one game is a financial game, (vii) the at least one game is a financial forecasting game, (viii) the at least one game is a betting game, (ix) the at least one game is a sports game, (x) the at least one game is a game with questions, (xi) the at least one game is a quizz, (xii) the at least game is a skill game, (xiii) the at least game has a part of skill, (xiv) the at least game is a game of knowledge, and (xv) the at least game has a part of knowledge, and (b) the at least one promotional offer is associated with at least one event, wherein the third determination to determine if the request is associated with the at least one available advantage is based at least on the outcome of the at least one event, and the at least one event is at least one of: (i) an event associated with the at least one user, (ii) an event associated with a shop, (iii) an event associated with money, (iv) an event associated with a number, (v) an event associated with a result, and (vi) an event associated with sports.

A method is provided, said method 30, which is the method 18 further comprising at least one of: (a) receive at least one second payment from at least one other source than the at least one user, wherein the at least one second payment is associated with: (i) advertising, (ii) selling data, (iii) sponsoring, (iv) selling a service, (v) selling a product, (vi) at least one device, (vii) at least one mobile device, and (viii) at least one investor, (b) build databases with collected data, (c) sell data associated with the at least one user, (d) after the second determination use links to websites or mobile sites, and (e) use links to websites or mobile sites.

A method is provided, said method 31, which is the method 18 wherein the at least one user is located in a determined shop when he makes the request and at least one of: (a) the at least one category comprises items sold in the determined shop, (b) the at least one category is at least one of: (i) a product, (ii) a service, (iii) a shop, (iv) a website, (v) a category of products, (vi) a category of services, (vii) a category of shops, (viii) a category of websites, (ix) including at least one product, (x) including at least one service, (xi) including at least one shop, (xii) including at least one website, (xiii) a plurality of products, (xiv) a plurality of services, (xv) a plurality of shops, and (xvi) a plurality of websites, and (c) at least one of: (I) each advantage of the plurality of advantages, (II) at least one of the each advantage of the plurality of advantages, (III) each of the at least one promotional offer, and (IV) at least one of the at least one promotional offer, is at least one of: (i) associated with a product, (ii) associated with a service, (iii) associated with a shop, (iv) associated with a website, (v) associated with a category of products, (vi) associated with a category of services, (vii) associated with a category of shops, (viii) associated with a category of websites, (ix) associated with a plurality of products, (x) associated with a plurality of services, (xi) associated with a plurality of shops, and (xii) associated with a plurality of websites.

A method is provided, said method 32, which is the method 18 further comprising: causing a processor to execute a plurality of instructions stored on at least one memory device to: (a) determine a time in the at least one period of the plurality of periods, and (b) if the time is determined in the at least one period of the plurality of periods: (i) cancel the third determination, (ii) if the second determination is true, make a fourth determination wherein the fourth determination is to determine if: (iia) the request is associated with the at least one available advantage, and (iib) the request is received after the determined time in the at least one period of the plurality of periods, and (iii) if the fourth determination is true, provide the at least one available advantage to the at least one user.

A method is provided, said method 33, which is the method 18 further comprising: (a) determine at least one supplier wherein the at least one supplier is associate with the at least one category, and (b) contact at least one of each of the at least one supplier associated with the at least one category wherein at least one of: (i) at least one of each of the at least one supplier associated with the at least one category is invited to make a business offer to the at least one user, (ii) at least one of each of the at least one supplier associated with the at least one category is invited to make a business offer to the at least one user wherein the business offer to the at least one user is associated with a quantity, (iii) at least one of each of the at least one supplier associated with the at least one category makes a business transaction with the at least one user, (iv) at least one of each of the at least one supplier associated with the at least one category makes a business transaction with the at least one user wherein the business transaction with the at least one user is associated with a quantity, and (v) at least one of each of the at least one supplier associated with the at least one category is invited to use collected data from the at least one user.

A method is provided, said method 34, which is the method 18 further comprising: (a) include in at least one of the at least one promotional offer a plurality of items to be sold, said the plurality of items, wherein: (i) the plurality of items is associated with the plurality of advantages included in the at least one of the at least one promotional offer, (ii) each of the items of the plurality of items is at least one of: (iia) a product, (iib) a service, (iic) a plurality of products, (iid) a plurality of services, and (iie) a plurality of products and services, (iii) each item of the plurality of items is associated with each advantage of the plurality of advantages included in the at least one of the at least one promotional offer, and (b) if the third determination is true: (i) determine if the at least one available advantage is associated with the at least one of the at least one promotional offer, (ii) if the determination is that the at least one available advantage is associated with the at least one of the at least one promotional offer, determine the item of the plurality of items which is associated with the at least one available advantage, said the promoted item, and (iii) if the at least one available advantage is provided to the at least one user, sell the promoted item to the at least one user.

The preceding paragraphs are disclosed for a method as well as for a system. In the preceding paragraphs, the reader can replace the word method by the word system. This applies to paragraphs disclosing said method 18 to said method 34. This also applies to any interpretation or use of these said methods—or systems—in the disclosure, and in other later disclosures.

### Detailed Description—Part Two

The method comprises causing a processor to execute a plurality of instructions stored on at least one memory device to cause the following embodiment. A plurality of periods is determined. At least one category is determined. At least one promotional offer is determined. Each of the at least one promotional offer includes a plurality of advantages to be offered. For each of the at least promotional offer, each advantage of the plurality of advantages is associated with the same at least one of the at least one category, and the plurality of advantages is associated with the plurality of periods wherein: each advantage of the plurality of advantages is associated with at least one period of the plurality of periods, and at least two periods of the plurality of periods are associated with at least one advantage of the plurality of advantages. For at least one period of the plurality of periods, do the following. Enable at least one user to make at least one request wherein: the at least one request is associated with at least one of the at least one category, the at least one request is associated with the at least one period of the plurality of periods, and the at least one request is associated with a payment wherein the payment is either equal to zero, or greater than zero, said the request. Make a first determination, wherein the first determination is to determine if the request is received from the at least one user. If the first determination is true, make a second determination wherein the second determination is to determine if at least one advantage of the plurality of advantages included in each of the at least one promotional offer is associated with the at least one period of the plurality of periods, and associated with the at least one of the at least one category associated with the request. If the second determination is true, determine the at least one advantage of the plurality of advantages included in each of the at least one promotional offer which is associated with the at least one period of the plurality of periods, and the at least one of the at least one category associated with the request, said the at least one available advantage. If the second determination is true, make a third determination wherein the third determination is to determine if the request is associated with the at least one available advantage. If the third determination is true, provide the at least one available advantage to the at least one user.

In one embodiment, a promotional offer is determined and includes advantages to be offered to users. Users can be the general public, or targeted users, or predetermined categories of users. This depends on the definition of the promotional offer, and of the choice made about targets to reach, and types of public to address. The advantages to be offered can be any type of advantage a man of the art can think of. For example, reimbursement of the total price, of a part of the price, coupons, rebates, discounts, additional quantities offered, associated gifts, and any type of premium offer. The advantages can be the same or different, whether in part or in totality. The promotional offer is associated with a plurality of periods, and all of the advantages to be offered are associated with some of the periods. It is possible that a period is associated with no advantage or zero advantage, one advantage or more than one advantage, but all advantages are associated with at least two periods. At least one category is determined, and all of the advantages of the promotional offer are associated with the same at least category. All of the advantages can be associated to one or several same categories. All of the advantages have to be associated with a category. A category can be any type of category, like a type of product or service or shop or price range, a product, a service a shop, an any type of categorization a man of the art would consider as useful. As illustrative examples, a promotional offer for a determined refrigerator can be associated with one category: home equipment, or two categories: refrigerators and low price range, or four categories: brand x, kitchen equipment, refrigerators, shop y, and any other useful categorization possibility. The user can make a request, the request being associated with at least one category. This request can be done through a browser, through email, on a land-line, or fixed device, or mobile device. As illustrative examples, a user can visit a website and select one or several categories, like for example, home products, or refrigerator and low price range, or kitchen equipment and brand x and shop y. Categories can be predetermined or not predetermined. Categories can be post-determined or not post-determined. As illustrative examples, categories can be predetermined, advantages are associated with them, and those categories are proposed to the user for his selection, or categories can be post-determined as the user can express an open request and an expert system then creates appropriate selection categories, or categories are predetermined and the advantages are associated with them but they can be grouped and renamed for the user, or the grouping and renaming can depend on the number of available advantages at the moment of the request, or depend on the user collected data or context. The request of the user can be associated with a payment or not associated with a payment. A registration of the user can be associated with a payment or not associated with a payment. The user can browse or request one category, or a limited number of categories, or all categories, or selected categories. The period is determinant and distinctive. When the user makes the request, which is associated for example with one category, the method or system determines if advantages are associated with that category for the considered period, and what are these advantages. It works a similar way if there are two or more categories. The user then applies for one or some or all of these available advantages. This can be done by asking a confirmation to the user, or a registration, or a selection, or without asking, or be done automatically. As illustrative examples, the user can select two categories like low price range and refrigerator, and be offered the possibility of getting three advantages—or one only of the three—: a first one for a first refrigerator, like a reimbursement in part; a second one for a second refrigerator, like an extension of guarantee offered for three years, a third one for a rebate on any refrigerator of the shop x. The system then determines if the user gets the requested advantage or not. This can be done based on any criteria. As illustrative examples, a period can be from 9 pm to 12 am the following day, and a user knows if he is given the requested advantage or advantages at the end of the period. A determination can be based on a the number of fidelity points of a user, or based on a ranking of users, or based on points a user can win in associated games, or on chance or skill, money, or any other criteria. A user may also know instantly if he is selected based on an instant win game, or based on a sufficient number of points, or because the availability of the advantages is done at a time of the period users are not aware of and the user is the first to request after this time.

In one embodiment, x advantages are proposed to prospects or customers and the promotion is active during one period of y days. But the number of advantages propose each day is specified. For example, 1000 advantages are proposed to prospects or customers and the promotion is active during one period of 10 days. But it is specified that, for example, 100 advantages are proposed each day during the period of 10 days. The number of advantages proposed each day can be equal.

In one embodiment, x advantages are proposed to prospects or customers and the promotion is active during one period of y days. But the number of advantages propose each day is specified. For example, 1000 advantages are proposed to prospects or customers and the promotion is active during one period of 10 days. But it is specified that, for example, during the period of 10 days, 150 advantages are proposed the first three days, 100 advantages are proposed the next four days, and 50 advantages are propose the last three days. The number of advantages proposed each day can be different.

In one embodiment, x advantages are proposed to prospects or customers and the promotion is active during one period of y days. But the number of advantages proposed each day is specified. For example, 1000 advantages are proposed to prospects or customers and the promotion is active during one period of 10 days. But it is specified that, for example, during the period of 10 days, 200 advantages are proposed the first two days, 150 advantages are proposed the next three days, zero advantage is proposed on the sixth day and on the seventh day, and 50 advantages are proposed the last three days. The number of advantages proposed some days can be zero.

Advantages are any type of advantage a man of the art can think of. This includes advantages being or being associated with: consumer sales promotion techniques, trade sales promotion techniques, retail mechanics, discounts and allowances. This includes advantages being or being associated with: price deal, loyalty marketing, loyal reward program, cents-off deal, price-pack deal, coupons, loss leader, free-standing insert, on-shelf couponing, checkout dispensers, online couponing, online sales promotion, mobile couponing, online interactive promotion game, rebates, instant rebates, contests, sweepstakes, games, point-of-sale displays, kids eat free specials, sampling, trade allowances, dealer loader, trade contest, point-of-purchase displays, point-of-purchase promotions, training programs, push money, trade discounts, premiums, incentive, supplements buy x get y free, three for two, buy a quantity for a lower price, get x % of discount on weekdays, free gift with purchase, discounts and allowances dealing with payment, prompt payment discount, preferred payment method discount, partial payment discount, sliding scale, forward dating, seasonal discount, discounts and allowances dealing with trade, bargaining, trade discount, trade rate discount, trade-in credit, discounts and allowances dealing with quantity, cumulative quantity discount, non-cumulative quantity discount, dependence of price on quantity, discounts and allowances dealing with customer characteristics, disability discount, educational or student discount, employee discount, military discount, age-related discounts; special prices offered to friends of the seller, special prices offered to local residents, discount card, other discounts and allowances, promotional allowances, brokerage allowance, gift to the prospect, benefit for the prospect, gift to the customer, benefit for the customer. For each type of advantage listed above, one embodiment is particularly disclosed. The number of particular embodiments disclosed corresponds to the number of types listed above. In addition, it is possible to combine each of these particular embodiments, in any order, in part or in totality with at least one other particular embodiment or with at least one other combined embodiment. These embodiments resulting from combination are disclosed.

In one embodiment, the category is a product. For example, the category can be a car. For example, the category can be a book. For example, the category can be a song. For example, the category can be a film. For example, the category can be a television. For example, the category can be a smartphone. For example, the category can be any product. For example, the category can be a determined product.

In one embodiment, the category is a service. For example, the category can be an insurance contract. For example, the category can be a travel. For example, the category can be a tuition fee. For example, the category can be online streaming. For example, the category can be online gaming. For example, the category can be any service. For example, the category can be a determined service.

In one embodiment, the category is a shop. For example, the category can be a supermarket. For example, the category can be any supermarket. For example, the category can be a determined supermarket.

In one embodiment, the category is a website. For example, the category can be an e-commerce website, like Amazon. For example, the category can be a social network, like Facebook or Twitter. For example, the category can be a gaming website. For example, the category can be a media website, like the website of the Wall Street Journal. For example, the category can be any website. For example, the category can be a determined website.

In one embodiment, the category is a category of products. For example, the category can be a group of products in a determined price range. For example, the category can be household appliances. For example, the category can be financial products. For example, the category can be a particular category of financial products, for example the dot options as disclosed in U.S. patent application Ser. No. 12/003,394, filed on Dec. 26, 2007, which issued as U.S. Pat. No. 8,118,654. For example, the category can be luxury goods. For example, the category can be discounted products. For example, the category can be any category of products. For example, the category can be a determined category of products.

In one embodiment, the category is a category of services. For example, the category can be a group of services in a determined price range. For example, the category can be tourism products. For example, the category can be financial services. For example, the category can be a particular category of financial services. For example, the category can be discounted services. For example, the category can be any category of services. For example, the category can be a determined category of services.

In one embodiment, the category is a category of shops. For example, the category can be department stores. For example, the category can be grocery stores. For example, the category can be sport shops. For example, the category can be specialized shops. For example, the category can be luxury stores. For example, the category can be shops located in determined areas. For example, the category can be discount stores. For example, the category can be retail stores. For example, the category can be wholesale stores. For example, the category can be clearance stores. For example, the category can be any category of stores or shops. For example, the category can be a determined category of stores or shops.

In one embodiment, the category is a category of websites. For example, the category can be e-commerce websites. For example, the category can be social networks. The category can be American websites. For example, the category can be gaming websites. For example, the category can be entertainment websites. The category can be information websites. For example, the category can be any category of websites. For example, the category can be a determined category of websites.

In one embodiment, the category is comprising at least one product. For example, the category can be a car and a guarantee contract. For example, the category can be a house and a credit. For example, the category can be a motorbike and a helmet. For example, the category can be any category comprising at least one product. For example, the category can be a determined category comprising at least one product.

In one embodiment, the category is comprising at least one service. For example, the category can be an insurance contract and a house. For example, the category can be a subscription and twelve magazines. For example, the category can be any category comprising at least one service. For example, the category can be a determined category comprising at least one service.

Different additional embodiments are disclosed. In one embodiment, the promotional offer includes a plurality of items to be sold. The promotional offer includes a plurality of advantages to be offered along with the corresponding plurality of items to be sold. For example, it can be an offer of 30% price discount on a determined refrigerator for one week. Then, the plurality of advantages is the plurality of rebates offered, whereas the plurality of items is the plurality of refrigerators which are the discounted refrigerators.

In one embodiment, each of the items to be sold can be a product. The example of the 30% discount on refrigerators described above is an example of it.

In one embodiment, each of the items to be sold can be a service. For example, it can be an offer of reimbursement on the two first weeks of a one year language teaching course. Then the plurality of advantages is the plurality of reimbursements offered, whereas the plurality of items is the plurality of the corresponding courses.

In one embodiment, each of the items to be sold can be a plurality of products. For example, it can be an advantage offered for quantity. For example, it can be a price rebate or any other advantage, for the buying of two items at the same time, like two packs of soda would give you 20% discount on the total price. Then, the plurality of advantages is the plurality of discounts, whereas the plurality of items is the plurality of two packs of soda. In that case, the item itself is a plurality of products, the product being a pack of soda.

In one embodiment, each of the items to be sold can be a plurality of services. For example, it can be a discounted per hour price or per service price, or any other advantage, on a service after a determined number of hours. For example, you can have a plurality of items being a plurality of 15 taxi travels, and a plurality of advantages being no rebate for the 10 first ones and a discounted price on the last 5 fives ones.

In others embodiments, the promotional offer can include any combination of the preceding. For example, the plurality of products can be a plurality of products of different kinds. For example, a plurality can be composed of refrigerators and audio systems and windows. You can have a plurality of products and pluralities. For example, an item of the plurality of items could be a refrigerator, or two coffee machines, or more than five items bought in the month. The same goes for services. For example, you can also have any combination of products and services. For example, a plurality of items can be a travel to Venice, an hotel room for a week, a book on Italy, three bottles of Italian wine, and an insurance. Another example is a plurality of items composed of a new car, three specific options like a specific color or big wheels, an insurance, and an extended guarantee.

In one embodiment, the plurality of items can be composed of all items sold in a shop or by a company. In one embodiment, it can be composed of a full category of items sold in a shop or by a company, wherein the word category has the sense defined in the disclosure. For example, a category can be a price range, a type of product or service, or any other categorization being considered as useful for the man of the art or for commercial or marketing purposes. In one embodiment, the plurality of items can be composed of items being sold in different shops or by different companies. For example, a plurality can be composed of a car sold by a car shop and an insurance contract sold by an insurance company.

In all those cases described where the plurality of advantage is associated with a plurality of items, the method can be used exactly the same way, but with selling the item to the user. Then, if the determination is that the at least one available advantage is associated with the at least one of the at least one promotional offer, the item of the plurality of items which is associated with the at least one available advantage is determined, said the promoted item, and if the at least one available advantage is provided to the at least one user, the promoted item is sold to the at least one user. It is easy to understand that in some cases, the advantage can be attributed in itself, like giving a coupon, for example. It is also easy to understand that in some cases, the advantage is relative to a purchase, like providing discounts, rebates, or reimbursements, for example. Then providing the advantage and selling the product are the same thing. Using the method for promoting a product, a service, a plurality of products, a plurality of services, and any combination thereof is explicitly disclosed in this disclosure.

### General Remarks

In this application, different embodiments, or methods, or systems, are disclosed. They may be disclosed under a same or different titles. Each embodiment or method or system disclosed in this application can be considered separately. Each embodiment, or method, or system disclosed in this application can be combined with at least another one, in part or in totality, to form a new embodiment, or new method, or new system. Each combination can be made in any order. Each combination can include any type of disclosed source. Each combination can be made whatever the title under which the parts to combine have been disclosed.

In previous related applications, which are incorporated in this one by reference, different embodiments, or methods, or systems, have been disclosed. They may have been disclosed under a same or different titles. Each embodiment or method or system disclosed in the previous related applications can be considered separately. Each embodiment, or method, or system disclosed in these previous related applications can be combined with at least another one, in part or in totality, to form a new embodiment, or new method, or new system. Each combination can be made in any order. Each combination can include any type of disclosed source. Each combination can be made whatever the title under which the parts to combine have been disclosed. Each combination can be made whatever the application wherein the parts to combine have been disclosed.

The embodiments or methods or systems disclosed in this application and the embodiments or methods or systems disclosed in the previous related applications can also be combined, in part or in totality, to form new embodiments, or new methods, or new systems. Each embodiment, or method, or system disclosed in this application and in the previous related applications can be combined with at least another one, in part or in totality, to form a new embodiment, or new method, or new system. Each combination can be made in any order. Each combination can include any type of disclosed source. Each combination can be made whatever the title under which the parts to combine have been disclosed. Each combination can be made whatever the application wherein the parts to combine have been disclosed.

The embodiments or methods or systems disclosed in this application or the embodiments or methods or systems disclosed in the previous related application can also be combined, in part or in totality, with future contents disclosed in future continuation applications to form new embodiments, or new methods, or new systems. Each embodiment, or method, or system disclosed in this application and in the previous related applications and in future continuation applications can be combined with at least another one, in part or in totality, to form a new embodiment, or new method, or new system. Each combination can be made in any order. Each combination can include any type of disclosed source. Each combination can be made whatever the title under which the parts to combine have been or will be disclosed. Each combination can be made whatever the application wherein the parts to combine have been or will be disclosed.

All embodiments, methods and systems considered in the preceding paragraphs include, or can include, the use of a touchscreen. This applies to each embodiment, each method and each system disclosed in this application, and in previous related applications, and in future related applications. This also applies to new embodiments, and new methods, and new systems being formed by combination, as described hereabove.

Explicitly, combination of embodiments include embodiments associated with games, embodiments associated with gaming, embodiments associated with finance, embodiments associated with financial instruments, and embodiments associated with promotional offers. The same goes for combination of methods, or systems. In the previous paragraphs, methods for business model are considered as a particular method, and previous paragraphs also applies to them.

### Financial Forecasting Game

Complements or details are disclosed concerning the financial forecasting game. In the previous applications, as well as in the current application, different embodiments, or methods, or systems are disclosed. The disclosed embodiments, or methods, or systems can be considered separately or combined, in part or in totality.

In one embodiment, the players are ranked.

In one embodiment, the players are ranked based on a scoring. The scoring method is disclosed in the previous related applications.

In one embodiment, a first ranking of the first set for one of the requests is determined, for at least one of the requests, and the determination to know if the first set is associated with one of a plurality of prizes is based on the first ranking of the first set.

In one embodiment, a first ranking of the first set associated with the player is determined, for at least one of the requests, a second ranking of the second set associated with the second player is determined, for at least one of the second requests, the determination to know if the first set is associated with one of a plurality of prizes is based on the first ranking of the first set, and the determination to know if the second set is associated with one of the plurality of prizes is based on the second ranking of the second set.

In one embodiment, a first ranking of the first set associated with the player is determined, for at least one of the requests, a second ranking of the second set associated with the second player is determined, for at least one of the second requests, the determination to know if the first set is associated with one of a plurality of prizes is based on the first ranking of the first set, and the determination to know if the second set is associated with another one of the plurality of prizes is based on the second ranking of the second set.

In one embodiment, a ranking for at least one of the plurality of sets of forecasts generated for the player is determined, for at least one of the requests, and the determination to know if the at least one set of forecasts is associated with one of a plurality of prizes is based on the determined ranking of that set.

### Customized Online Game

The method consists in personalizing any online game. For example, a lottery traditionally has a user interface with numbers to select in a grid. A way of personalization can be to offer a user interface with other items to select than numbers. For example, items can be letters, names dates, images, videos, sounds, colors, first names. In the disclosure, we call “grid content” items which are used instead of the numbers used in a traditional lottery grid.

The method has many advantages. A user will find it more useful to play a grid with first names or places as it is then easier for him to memorize what he played. A website will find it more appropriate to offer a game with a personalized content which is related to the website content, like grid contents based on animals for a website dealing with animals, cars for a web site related to cars, countries for a travel agency, plants for a therapy related website, etc. The reader is of course asked to read these associations as illustrative examples of any association between a grid and a website which would have related contents. An advantage for a lottery operator is to be able to propose, with a unique system, different personalized user interfaces. The operator has, for example, the opportunity to create partnerships with websites in a more efficient way. The operator can also make an animation for players by changing his grid environment by changing the interface.

In one embodiment, the grid content is related to a product. In one embodiment, the grid content is related to a brand. In one embodiment, the grid content is related to a shop. In one embodiment, the grid content is related to a company.

### Financial Disclosure—Part One

In the financial field, markets of options were settled before the arrival of Internet. They were an appropriate way to address a large public of investors with an extensive offer of negotiable derivative products, based on predetermined strike prices of exercise and dates of expiration for each particular asset. Then, the development of Internet gave to the public a more convenient access to these markets. But basically these markets have not changed until now. The products offered remain the same. Some specialized banks have joined, in the same model, their own offers of negotiable warrants on stock indexes or currencies rates of change, which can be traded in the same way using phone, Internet or office counters.

Independently, some merchants banks elaborate on demand for corporate customers private tailor-made options for the coverage of their business activities.

What is needed now is a new offer, destined to the general public, of tailor-made options, that is to say options where the assets, which might be simple or combined, the prices of exercise and the dates of expiration could be determined by the customers themselves. This offer could be particularly useful for the coverage of foreign assets, or more generally diversified assets, hold by private investors on financial markets. Previous disclosure concerning “multi-cover options” is in U.S. Pat. No. 8,118,654 (page 26 line 44 to page 29 line 36).

This new offer, meant for the general public, should be proposed by a financial institution using Internet, not only as a vector of presentation and distribution like now, but also as a vector of instantaneous calculations for the on-line production of tailor-made options. These tailor-made options, particularly the coverage options, might be negotiable or more likely non-negotiable.

A version of the offer, is adapted in an embodiment for a business to business environment.

### Multiple—Monetization for Lotteries and Free Games—Remarks

Disclosure has already been made of the method in application Ser. No. 13/374,699. Namely, parts of the application under titles Multiple, Lottery, Other free games, Complements are related to the current disclosure.

In many states, the legislation is currently restrictive for paid-for money games. For example, in such states, a game of chance can't be sold to players. But a game can sell services to players, and the disclosed invention is such a service. This offers the possibility for many games to abide the law and to make players pay for additional services.

Disclosure has already been made of the method in application Ser. No. 13/374,699. Namely, parts of the application under titles Multiple, Lottery, Other free games, Complements are related to the current disclosure.

Preliminary remark is made that in some games, the purpose of the game is to win some money or a valuable prize having a prize value. These are so-called “money games”. Traditionally, this type of game is a paid-for game. The money received from the players is used in part by the game organiser to pay the winners or to finance their prizes. Basically, what a player buys is not a right to play, but a right to win, or, to be even more specific, a right to have the opportunity to win. What the player has to do to win may vary from one game to another. But, what does not vary is that, from the financial point of view, each play is a contract between a player and the game organizer: the player buys a right to win some money or a valuable prize under predetermined circumstances disclosed in the game rule.

With the Internet, new business models have come out. They are free for the user and financed by advertising and other types of revenues. Free lotteries, namely, have been launched, in which a player can play for free and win money or valuable prizes. Other types of free games exist, such as free poker games, free horse racing games, free betting, all enabling players to win money or valuable prizes. Like for paid-for games, each play is a contract between a player and the game organizer: the player is given, for free, a right to win some money or a valuable prize under predetermined circumstances disclosed in the game rule. Each play is a contract, registered for free by the game organiser. Each play correspond to a registration to win in the game.

For these so-called “money games”, whether paid-for or free for the player, the common understanding is that a play and a registration to win are synonyms. For example, in a lottery game, the player has to select several numbers and then to validate his grid. The common understanding is that one play is one grid: for example, he plays twice a week means that he validates two grids per week. The selection of one number of the grid, for example, is not the play. The unit of play is what is necessary and sufficient to entitle the player to win some money or a valuable prize.

This common understanding applies to the current disclosure, as well as the previous disclosures, and namely the related disclosure in application Ser. No. 13/374,699.

### Multiple—Monetization for Lotteries and Free Games—Details—Part One

The following paragraphs are disclosed for a method as well as for a system. In the following paragraphs, the reader can replace the word method by the word system. This applies to paragraphs disclosing said method A1 to said method A10. This also applies to any interpretation or use of these said methods—or systems—in the disclosure, and in other later disclosures.

For a system, the text of the method A1 will further comprise: (i) at least one input device, (ii) at least one display device, (iii) a processor, and (iv) at least one memory device which stores a plurality of instructions which when executed by the processor, cause the processor to operate with the one at least display device and the one at least input device to do what is disclosed in method A1.

A method is provided, said method A1, which is a method for a game of chance, said the game, comprising: causing a processor to execute a plurality of instructions stored on at least one memory device to: (a) determine a number n, (b) determine at least one period p, (c) entitle at least one player to participate in the game, including: (i) entitle the at least one player to register each at most n participation registrations to win in the game during the at least one period p, wherein: (I) the at most n participation registrations to win in the game is associated with the at least one player, (II) n is the predetermined number n, and (III) p is the predetermined at least one period p, said the at most n registrations, wherein: (ia) each of the at most n registrations is associated with at least one data input from the at least one player, wherein the at least one data input from the at least one player associated with each of the at most n registrations is required by a rule of the game, said the at least one data input, (ib) each of the at most n registrations is associated with at least one determination of winning, wherein the at least one determination of winning is based at least on the rule of the game, and wherein the at least one determination of winning is associated with either (i) a win, or (ii) a loss, wherein the win is associated with a prize having a prize value, wherein the prize value is greater than zero, and (ic) each of the at most n registrations is associated with a first payment from the at least one player, and wherein the first payment from the at least one player is equal to zero, (ii) enable the at least one player to have at least one use of a first game user interface, wherein: (iia) the at least one player can use the first game user interface to register the at most n registrations either (i) in part, or (ii) in totality, and (iib) the at least one use of the first game user interface is associated with a second payment from the at least one player, and wherein the second payment from the at least one player is equal to zero, and (iii) enable the at least one player to have at least one use of a second game user interface, wherein: (iiia) the at least one player can use the second game user interface to register the at most n registrations either (i) in part, or (ii) in totality, (iiib) the second game user interface enables the at least one player to use a system to register automatically a plurality of the at most n registrations, said the registration system, and (iiic) the at least one use of the second game user interface is associated with a third payment from the at least one player, and wherein the third payment from the at least one player is greater than zero, and (d) for each of the at most n registrations registered by the at least one player, do the at least one determination of winning, and (e) if the at least one determination of winning is associated with the win, provide the prize associated with the win to the at least one player.

A method is provided, said method A2, which is the method A1 wherein at least one of: (i) the game is a game of pure chance, (ii) the game has a part of chance, (iii) the game is a game of mixed chance and skill, (iv) the game is a lottery game, (v) the game is a forecasting game, (vi) the game is a financial game, (vii) the game is a financial forecasting game, (vii) the game is a betting game, and (viii) the game is a sports game.

A method is provided, said method A3, which is the method A1 wherein the game is at least one of: (a) a game of chance, (b) a lottery game and (c) a forecasting game, further comprising: the game has a total revenue of the game, and wherein the total revenue of the game includes at least one of: (i) a revenue from the at least one player, (ii) a revenue exclusively from the at least one player, (iii) a revenue from at least one other source than the at least one player, (iv) a revenue exclusively from at least one other source than the at least one player, (v) a revenue from advertising, (vi) a revenue from selling data, (vii) a revenue from sponsoring, (viii) a revenue from selling a service, (ix) a revenue from selling a product, (x) a revenue from at least one device, and (xi) a revenue from at least one mobile device.

A method is provided, said method A4, which is the method A1 wherein the game is at least one of: (a) a game of chance, (b) a lottery game and (c) a forecasting game, and wherein at least one of: (i) each of the at most n registrations is associated with the same at least one determination of winning, (ii) each of the at most n registrations is associated with a different at least one determination of winning, (iii) at least two of the at most n registrations are associated with the same at least one determination of winning, (iv) at least two of the at most n registrations are associated with different at least one determinations of winning, (v) each of the at most n registrations is associated with a same odds of winning, (vi) each of the at most n registrations is associated with a different odds of winning, (vii) at least two of the at most n registrations have same odds of winning, (viii) at least two of the at most n registrations have different odds of winning, (ix) each of the at least one data input from the at least one player associated with each of the at most n registrations has a same structure, (x) each of the at least one data input from the at least one player associated with each of the at most n registrations has a different structure, (xi) at least two of the at least one data input from the at least one player associated with each of the at most n registrations have the same structure, (xii) at least two of the at least one data input from the at least one player associated with each of the at most n registrations have different structures, (xiii) the at least one data input from the at least one player associated with each of the at most n registrations is at least one of: (a) a number, (b) an option, (c) an image, (d) a letter, (e) a selection, and (f) electronic data, and (xiv) at least two of the at least one data input from the at least one player associated with each of the at most n registrations is at least one of: (a) a number, (b) an option, (c) an image, (d) a letter, (e) a selection, and (I) electronic data.

A method is provided, said method A5, which is the method A1 wherein the game is at least one of: (a) a game of chance, (b) a lottery game and (c) a forecasting game, and wherein the registration system enables the at least one player to at least one of: (i) determine preferred numbers, (ii) determine preferred options, (iii) determine preferred items, (iv) determine preferred images, (v) determine preferred letters, (vi) play at least two of the at most n registrations, (vii) play at least one of the at most n registrations, (viii) play a plurality of the at most n registrations, (ix) play at random, (x) play automatically, (xi) play based at least on an expert, (xii) play based at least on an expert system, (xiii) play based at least on general statistics, (xiv) play based at least on game statistics, (xv) play based at least on the game statistics, (xvi) play based at least on the at least one player game statistics, (xvii) play based at least on the at least one player personal data, (xviii) play based at least on at least two of the at least one player game statistics, (xix) play based at least on at least two of the at least one player personal data, (xx) play based at least on a preferred strategy, (xxi) play based at least on a medium, and (xxii) play based at least on lucky numbers.

A method is provided, said method A6, which is the method A1 wherein the game is at least one of: (a) a game of chance, (b) a lottery game and (c) a forecasting game, and wherein at least one of: (a) the first game user interface and the second user interface can be accessed on a same device at a same or different times, (b) the first game user interface and the second user interface can be accessed on different devices at a same or different times, (c) the first game user interface and the second user interface can be accessed on at least one same device at a same or different times, (d) the first game user interface is associated with a touch screen, and (e) the second game user interface is associated with a touch screen.

A method is provided, said method A7, which is the method A1 wherein the game is at least one of: (a) a game of chance, (b) a lottery game and (c) a forecasting game, and further comprising: (a) change the first payment from the at least one player to be greater than zero, (b) change the second payment from the at least one player to be either (i) equal to zero, or (ii) greater than zero, (c) change the third payment from the at least one player to be either (i) equal to zero, or (ii) greater than zero, and (d) if the at least one player plays a plurality of the n plays, apply a discount rate to the first payment from the at least one player, wherein the discount rate is greater than zero.

A method is provided, said method A8, which is the method A1 wherein the game is at least one of: (a) a game of chance, (b) a lottery game and (c) a forecasting game, further comprising: (a) change the third payment from the at least one player to be equal to zero, and (b) receive at least one payment from at least one other source than the at least one player, wherein the at least one payment is associated with: (i) advertising, (ii) selling data, (iii) sponsoring, (iv) selling a service, (v) selling a product, (vi) at least one device, (vii) at least one mobile device, and (viii) at least one investor.

A method is provided, said method A9, which is the method A1 wherein the game is at least one of: (a) a game of chance, (b) a lottery game and (c) a forecasting game, further comprising at least one of: (i) each of the at most n registrations is associated with a probability of winning, wherein the probability of winning is the same or different for each of the at most n registrations, (ii) at least two of the each of the at most n registrations are associated with a probability of winning, wherein the probability of winning is the same or different for the at least two of the each of the at most n registrations, (iii) each of the at most n registrations is associated with a probability of winning, wherein the probability of winning is disclosed, (iv) at least two of the each of the at most n registrations are associated with a probability of winning, wherein the probability of winning is disclosed, (v) the at least one determination of winning associated with each of the at most n registrations is the same or different for each of the at most n registrations, (vi) the at least one determination of winning associated with each of the at most n registrations is the same or different for at least two of the at most n registrations, and (vii) the at least one determination of winning associated with each of the at most n registrations is based at least on at least one of: (a) a ranking, (b) a drawing, and (c) a comparison.

A method is provided, said method A10, which is the method A1 comprising at least one of: (i) the prize value associated with the win is the same or different for each or at least two of the at least one player, (ii) the prize value associated with the win is the same or different for each or at least two of the at most n registrations, (iii) the prize value associated with the win is the same or different for each or at least two of the at least one determination of winning, and (iv) the prize value is calculated based at least on a formula, the formula being either (a) disclosed, or (b) not disclosed.

The preceding paragraphs are disclosed for a method as well as for a system. In the preceding paragraphs, the reader can replace the word method by the word system. This applies to paragraphs disclosing said method A1 to said method A10. This also applies to any interpretation or use of these said methods—or systems—in the disclosure, and in other later disclosures.

A method is provided, said method A21, which is a method for a business model, comprising: (A) operate a game of chance, said the game, including: (a) determine a number n, (b) determine a at least one period p, (c) entitle at least one player to participate in the game, including: (i) entitle the at least one player to register each at most n participation registrations to win in the game during the at least one period p, wherein: (I) the at most n participation registrations to win in the game is associated with the at least one player, (II) n is the predetermined number n, and (III) p is the predetermined at least one period p, said the at most n registrations, wherein: (ia) each of the at most n registrations is associated with at least one data input from the at least one player, wherein the at least one data input from the at least one player associated with each of the at most n registrations is required by a rule of the game, said the at least one data input, and (ib) each of the at most n registrations is associated with at least one determination of winning, and wherein the at least one determination of winning is based at least on the rule of the game, wherein the at least one determination of winning is associated with either (i) a win, or (ii) a loss, wherein the win is associated with a prize having a prize value, wherein the prize value is greater than zero, (ii) enable the at least one player to have at least one use of a first game user interface, wherein the at least one player can use the first game user interface to register the at most n registrations either (i) in part, or (ii) in totality, and (iii) enable the at least one player to have at least one use of a second game user interface, wherein: (iiia) the at least one player can use the second game user interface to register the at most n registrations either (i) in part, or (ii) in totality, and (iiib) the second game user interface enables the at least one player to use a system to register automatically a plurality of the at most n registrations, said the registration system, (d) for each of the at most n registrations registered by the at least one player, do the at least one determination of winning, and (e) if the at least one determination of winning is associated with the win, provide the prize associated with the win to the at least one player, and (B) determine parameters, including: (i) associate each of the at most n registrations played by the at least one player with a cost, said the cost, and determine the cost to be greater than zero, (ii) associate each of the at most n registrations played by the at least one player with a first payment from the at least one player, and determine the first payment from the at least one player to be equal to zero, (iii) associate the at least one use of the first game user interface with a second payment from the at least one player, and determine the second payment from the at least one player to be equal to zero, and (iv) associate the at least one use of the second game user interface with a third payment from the at least one player, and determine the third payment from the at least one player to be greater than zero.

A method is provided, said method A22, which is the method A21 wherein at least one of: (i) the game is a game of pure chance, (ii) the game has a part of chance, (iii) the game is a game of mixed chance and skill, (iv) the game is a lottery game, (v) the game is a forecasting game, (vi) the game is a financial game, (vii) the game is a financial forecasting game, (vii) the game is a betting game, and (viii) the game is a sports game.

A method is provided, said method A23, which is the method A21 wherein the game is at least one of: (a) a game of chance, (b) a lottery game and (c) a forecasting game, further comprising: the game has a total revenue of the game, and wherein the total revenue of the game includes at least one of: (i) a revenue from the at least one player, (ii) a revenue exclusively from the at least one player, (iii) a revenue from at least one other source than the at least one player, (iv) a revenue exclusively from at least one other source than the at least one player, (v) a revenue from advertising, (vi) a revenue from selling data, (vii) a revenue from sponsoring, (viii) a revenue from selling a service, (ix) a revenue from selling a product, (x) a revenue from at least one device, and (xi) a revenue from at least one mobile device.

A method is provided, said method A24, which is the method A21 wherein the game is at least one of: (a) a game of chance, (b) a lottery game and (c) a forecasting game, and wherein at least one of: (i) each of the at most n registrations is associated with the same at least one determination of winning, (ii) each of the at most n registrations is associated with a different at least one determination of winning, (iii) at least two of the at most n registrations are associated with the same at least one determination of winning, (iv) at least two of the at most n registrations are associated with different at least one determinations of winning, (v) each of the at most n registrations is associated with a same odds of winning, (vi) each of the at most n registrations is associated with a different odds of winning, (vii) at least two of the at most n registrations have same odds of winning, (viii) at least two of the at most n registrations have different odds of winning, (ix) each of the at least one data input from the at least one player associated with each of the at most n registrations has a same structure, (x) each of the at least one data input from the at least one player associated with each of the at most n registrations has a different structure, (xi) at least two of the at least one data input from the at least one player associated with each of the at most n registrations have the same structure, (xii) at least two of the at least one data input from the at least one player associated with each of the at most n registrations have different structures, (xiii) the at least one data input from the at least one player associated with each of the at most n registrations is at least one of: (a) a number, (b) an option, (c) an image, (d) a letter, (e) a selection, and (f) electronic data, and (xiv) at least two of the at least one data input from the at least one player associated with each of the at most n registrations is at least one of: (a) a number, (b) an option, (c) an image, (d) a letter, (e) a selection, and (f) electronic data.

A method is provided, said method A25, which is the method A21 wherein the game is at least one of: (a) a game of chance, (b) a lottery game and (c) a forecasting game, and wherein the registration system enables the at least one player to at least one of: (i) determine preferred numbers, (ii) determine preferred options, (iii) determine preferred items, (iv) determine preferred images, (v) determine preferred letters, (vi) play at least two of the at most n registrations, (vii) play at least one of the at most n registrations, (viii) play a plurality of the at most n registrations, (ix) play at random, (x) play automatically, (xi) play based at least on an expert, (xii) play based at least on an expert system, (xiii) play based at least on general statistics, (xiv) play based at least on game statistics, (xv) play based at least on the game statistics, (xvi) play based at least on the at least one player game statistics, (xvii) play based at least on the at least one player personal data, (xviii) play based at least on at least two of the at least one player game statistics, (xix) play based at least on at least two of the at least one player personal data, (xx) play based at least on a preferred strategy, (xxi) play based at least on a medium, and (xxii) play based at least on lucky numbers.

A method is provided, said method A26, which is the method A21 wherein the game is at least one of: (a) a game of chance, (b) a lottery game and (c) a forecasting game, and wherein at least one of: (a) the first game user interface and the second user interface can be accessed on a same device at a same or different times, (b) the first game user interface and the second user interface can be accessed on different devices at a same or different times, (c) the first game user interface and the second user interface can be accessed on at least one same device at a same or different times, (d) the first game user interface is associated with a touch screen, and (e) the second game user interface is associated with a touch screen.

A method is provided, said method A27, which is the method A21 wherein the game is at least one of: (a) a game of chance, (b) a lottery game and (c) a forecasting game, and further comprising: (a) change the first payment from the at least one player to be greater than zero, (b) change the second payment from the at least one player to be either (i) equal to zero, or (ii) greater than zero, (c) change the third payment from the at least one player to be either (i) equal to zero, or (ii) greater than zero, and (d) if the at least one player plays a plurality of the n plays, apply a discount rate to the first payment from the at least one player, wherein the discount rate is greater than zero.

A method is provided, said method A28, which is the method A21 wherein the game is at least one of: (a) a game of chance, (b) a lottery game and (c) a forecasting game, further comprising: (a) change the third payment from the at least one player to be equal to zero, and (b) receive at least one payment from at least one other source than the at least one player, wherein the at least one payment is associated with: (i) advertising, (ii) selling data, (iii) sponsoring, (iv) selling a service, (v) selling a product, (vi) at least one device, (vii) at least one mobile device, and (viii) at least one investor.

A method is provided, said method A29, which is the method A21 wherein the game is at least one of: (a) a game of chance, (b) a lottery game and (c) a forecasting game, further comprising at least one of: (i) each of the at most n registrations is associated with a probability of winning, wherein the probability of winning is the same or different for each of the at most n registrations, (ii) at least two of the each of the at most n registrations are associated with a probability of winning, wherein the probability of winning is the same or different for the at least two of the each of the at most n registrations, (iii) each of the at most n registrations is associated with a probability of winning, wherein the probability of winning is disclosed, (iv) at least two of the each of the at most n registrations are associated with a probability of winning, wherein the probability of winning is disclosed, (v) the at least one determination of winning associated with each of the at most n registrations is the same or different for each of the at most n registrations, (vi) the at least one determination of winning associated with each of the at most n registrations is the same or different for at least two of the at most n registrations, and (vii) the at least one determination of winning associated with each of the at most n registrations is based at least on at least one of: (a) a ranking, (b) a drawing, and (c) a comparison.

A method is provided, said method A30, which is the method A21 comprising at least one of: (i) the prize value associated with the win is the same or different for each or at least two of the at least one player, (ii) the prize value associated with the win is the same or different for each or at least two of the at most n registrations, (iii) the prize value associated with the win is the same or different for each or at least two of the at least one determination of winning, and (iv) the prize value is calculated based at least on a formula, the formula being either (a) disclosed, or (b) not disclosed.

A method is provided, said method A31, which is the method A21 wherein the game is at least one of: (a) a game of chance, (b) a lottery game and (c) a forecasting game, and wherein at least one of: (a) the cost is an average cost, (b) the cost is a predictive cost, (c) the cost is an actual cost, (d) the cost is a direct cost, (e) the cost is a complete cost, (f) the cost is a global cost, (g) the cost is a cash cost, (h) the cost is a provisional cost, (i) the cost is calculated based at least on the prize value, (j) the cost is associated with the prize value, (k) the cost is calculated based at least on probabilities, (l) the cost is calculated based at least on past values, (m) each of the at most n registrations played by the at least one player has the same cost, (n) each of the at most n registrations played by the at least one player has a different cost, (o) at least two of the at most n registrations played by the at least one player have the same cost, and (p) at least two of the at most n registrations played by the at least one player have different costs.

A method is provided, said method A32, which is the method A21 wherein the game is at least one of: (a) a game of chance, (b) a lottery game and (c) a forecasting game, and further comprising: (a) the game has an indicator, wherein the indicator is at least one of: (i) an operating result of the game, (ii) a revenue of the game, and (iii) a number of the at least one player, and (b) determine or change at least one parameter to optimize or increase the indicator, wherein the at least one parameter is at least one of: (i) the third payment from the at least one player associated with the at least one use of the second game user interface, (ii) the value n, (iii) the at least one period p, (iv) the prize value, (v) the at least one determination of winning, (vi) the at most n registrations, (vii) the cost, (viii) the first payment from the at least one player associated with each of the at most n registrations played by the at least one player, (ix) the second payment from the at least one player associated with the at least one use of the first game user interface, (x) the first game user interface, and (xi) the second game user interface.

### Multiple—Monetization for Lotteries and Free Games—Details—Part Two

The process or processes described in the following paragraphs can be read as comprised in a method. The process or processes described in the following paragraphs can be read as comprised in a system. The process or processes described in the following paragraphs can be read as comprised in a business model.

The method is disclosed for a game of chance. It is also disclosed for a game of skill, a game with a part of chance, and a game with a part of skill. It is also disclosed for any other type of game, like for example an internet game, a game on Facebook, a video game, an electronic game.

The method comprises causing a processor to execute a plurality of instructions stored on at least one memory device to cause the following embodiment. A number n is determined. A period p is determined. At least one player is entitled to participate in the game. The at least one player is entitled to register each at most n participation registrations to win in the game during the period p, wherein: the at most n participation registrations to win in the game is associated with the at least one player, n is the predetermined number n, and p is the predetermined period p, said the at most n registrations, wherein: each of the at most n registrations is associated with at least one data input from the at least one player, wherein the at least one data input from the at least one player associated with each of the at most n registrations is required by a rule of the game, said the at least one data input, each of the at most n registrations is associated with at least one determination of winning, wherein the at least one determination of winning is based on the rule of the game, and wherein the at least one determination of winning is associated with either a win, or a loss, wherein the win is associated with a prize having a prize value, wherein the prize value is greater than zero, and each of the at most n registrations is associated with a first payment from the at least one player, and wherein the first payment from the at least one player is equal to zero. The at least one player is enabled to have at least one use of a first game user interface, wherein: the at least one player can use the first game user interface to register the at most n registrations either in part, or in totality, and the at least one use of the first game user interface is associated with a second payment from the at least one player, and wherein the second payment from the at least one player is equal to zero. The at least one player is enabled to have at least one use of a second game user interface, wherein: the at least one player can use the second game user interface to register the at most n registrations either in part, or in totality, the second game user interface enables the at least one player to use a system to register automatically a plurality of the at most n registrations, said the registration system, and the at least one use of the second game user interface is associated with a third payment from the at least one player, and wherein the third payment from the at least one player is greater than zero. For each of the at most n registrations registered by the at least one player, do the at least one determination of winning is done. If the at least one determination of winning is associated with the win, the prize associated with the win is provided, to the at least one player.

Different additional embodiments are disclosed. In one embodiment, the game is a game of pure chance. For example, the game is a casino game. For example, the game is a roulette game. For example, the game is black jack game.

In one embodiment, the game is a game has a part of chance. For example, the game is a game where you can bet on horse races. For example, the game is a game of skill, but with a drawing to select one winner among different players having a same score. For example the game is a quizz, where players have to answer to questions, and the rule of the game considers that in the case of several winners, only one is selected to receive a prize, the selection being based on chance.

In one embodiment, the game is a game of mixed chance and skill. For example, the game is a poker game.

In one embodiment, the game is a lottery game.

In one embodiment, the game is a forecasting game. For example, the game is a game where you have to forecast who wins a race.

In one embodiment, the game is a financial game. For example, the game is a portfolio management game.

In one embodiment, the game is a financial forecasting game. For example, the game is one of the embodiments disclosed in this disclosure or in preceding related disclosures as a financial forecasting game. For example, the game is a financial forecasting game with combined assets.

In one embodiment, the game is a betting game. For example, the game is a game proposed by a bookmaker. For example, the game is a game where you bet on the outcome of an event.

In one embodiment, the game is a sports game. For example, the game is a game associated with sports. For example, the game is a game where you predict the results of matches. For example, the game is a game of forecasting football or baseball matches.

Different additional embodiments are disclosed. In one embodiment, the game organizer receives at least one payment from at least one other source than the at least one player. For example, the game organizer receives a payment from a company.

In one embodiment, the game organizer receives a payment which is associated with advertising. For example, the game organizer receives a payment for displaying an advertisement on his website.

In one embodiment, the game organizer receives a payment which is associated with selling data. For example, the game organizer receives a payment for selling email addresses.

In one embodiment, the game organizer receives a payment which is associated with sponsoring. For example, the game organizer receives a payment from a company which is sponsoring the game for a determined period. For example, the game organizer receives a payment as an affiliate. For example, the game organizer receives a payment from an affiliation program.

In one embodiment, the game organizer receives a payment which is associated with selling a service. For example, the game organizer receives a payment for collecting leads. For example, the game organizer receives a payment for a service of direct marketing. For example, the game organizer receives a payment for clicks. For example, the game organizer receives a payment for selling subscriptions. For example, the game organizer receives a payment for selling contracts. For example, the game organizer receives a payment for selling financial services.

In one embodiment, the game organizer receives a payment which is associated with selling a product. For example, the game organizer receives a payment for selling derived products. For example, the game organizer receives a payment for selling branded mugs or t-shirts. For example, the game organizer receives a payment for selling financial products. For example, the game organizer receives a payment for distributed products. For example, the game organizer receives a payment for any product.

In one embodiment, the game organizer receives a payment which is associated with at least one device. For example, the game organizer receives a payment if the player uses a determined device. For example, the game organizer receives a payment if the player uses a gaming device. For example, the game organizer receives a payment if the player uses a device sold or lend by a company. For example, the game organizer receives a payment if the player uses a device sold or lend by a casino or a hotel. For example, the game organizer receives a payment if the player uses a television. The payment can come from a company which is associated with the device. For example, the payment can come from a casino, a hotel, a gaming company, a television company, a producer, a distributor, and any type of company.

In one embodiment, the game organizer receives a payment which is associated with at least one mobile device. For example, the game organizer receives a payment if the player uses a mobile phone. For example, the game organizer receives a payment if the player uses a tablet. The payment can come from a company which is associated with the mobile device. For example, the payment can come from a casino, a hotel, a gaming company, a television company, a producer, a distributor, and any type of company.

In one embodiment, the game organizer receives a payment which is associated with at least one investor. For example, the game organizer receives a payment from shareholders. For example, the game organizer receives a payment associated with venture capital. For example, the game organizer receives a payment from online investors.

In one embodiment, the game is totally free for the player and the game organizer receives a payment from at least one other source than the player. For example, the first, second, and third payment from the player are equal to zero and the game organizer receives at least one payment from one of the sources described in the preceding paragraphs.

In one embodiment, the game is not totally free for the player and the game organizer receives a payment from at least one other source than the player. For example, the first, or the second, or the third payment from the player are different from zero and the game organizer receives at least one payment from one of the sources described in the preceding paragraphs.

Different additional embodiments are disclosed. In one embodiment, the first payment from the player is greater than zero and the player gets a discounted price. The player has to pay to play and he gets a discounted prices when he uses the second interface to register several plays at the same time. For example, the player can buy a lottery ticket for one dollar. But he also can buy, for example, twenty lottery tickets automatically registered, and in that case he can can a discounted price, for example seventeen dollars instead of twenty.

In one embodiment, the use of the first interface the player is using to register his play is free. For example, the player has to pay one dollar for the ticket, but the use of the first interface is not charged. For example, the player has to pay one dollar for the lottery grid, but the use of the first interface is not charged.

In one embodiment, the player has to pay to use of the first interface. For example, the player has to pay one dollar for the ticket, and he has to pay as well for the use of the first interface.

In one embodiment, the use of the first interface is charged as a specific fee. For example, the use can be charged ten cents per use. For example, the use can be charged ten percent of the price of the play in the case the player has to pay for the play.

In one embodiment, the use of the first interface is charged as a subscription fee. For example, the player has to pay a determined amount per week, or per month or per year to be entitled to use the first interface.

In one embodiment, the use of the second interface the player is using to register his play is free. For example, the player has to pay ten dollars for fifteen tickets, but the use of the second interface is not charged. For example, the player has to pay ten dollars for fifteen automatically generated lottery grids, but the use of the second interface is not charged.

In one embodiment, the player has to pay to use of the second interface. For example, the player has to pay ten dollars for eight tickets or lottery grids and he has to pay as well for the use of the second interface.

In one embodiment, the use of the second interface is charged as a specific fee. For example, the use can be charged ten cents per use. For example, the use can be charged ten percent of the price of the plays in the case the player has to pay for the plays.

In one embodiment, the use of the second interface is charged as a subscription fee. For example, the player has to pay a determined amount per week, or per month or per year to be entitled to use the second interface.

Different additional embodiments are disclosed. In one embodiment, the game organizer receives at least one payment from at least one other source than the at least one player. For example, the game organizer receives a payment from a company.

In one embodiment, the game organizer receives a payment which is associated with advertising. For example, the game organizer receives a payment for displaying an advertisement on his website.

In one embodiment, the game organizer receives a payment which is associated with selling data. For example, the game organizer receives a payment for selling email addresses.

In one embodiment, the game organizer receives a payment which is associated with sponsoring. For example, the game organizer receives a payment from a company which is sponsoring the game for a determined period. For example, the game organizer receives a payment as an affiliate. For example, the game organizer receives a payment from an affiliation program.

In one embodiment, the game organizer receives a payment which is associated with selling a service. For example, the game organizer receives a payment for collecting leads. For example, the game organizer receives a payment for a service of direct marketing. For example, the game organizer receives a payment for clicks. For example, the game organizer receives a payment for selling subscriptions. For example, the game organizer receives a payment for selling contracts. For example, the game organizer receives a payment for selling financial services.

In one embodiment, the game organizer receives a payment which is associated with selling a service. For example, the game organizer receives a payment for collecting leads. For example, the game organizer receives a payment for a service of direct marketing.

In one embodiment, the game organizer receives a payment which is associated with selling a product. For example, the game organizer receives a payment for selling derived products. For example, the game organizer receives a payment for selling branded mugs or t-shirts. For example, the game organizer receives a payment for selling financial products. For example, the game organizer receives a payment for distributed products. For example, the game organizer receives a payment for any product.

In one embodiment, the game organizer receives a payment which is associated with at least one device. For example, the game organizer receives a payment if the player uses a determined device. For example, the game organizer receives a payment if the player uses a gaming device. For example, the game organizer receives a payment if the player uses a device sold or lend by a company. For example, the game organizer receives a payment if the player uses a device sold or lend by a casino or a hotel. For example, the game organizer receives a payment if the player uses a television. The payment can come from a company which is associated with the device. For example, the payment can come from a casino, a hotel, a gaming company, a television company, a producer, a distributor, and any type of company.

In one embodiment, the game organizer receives a payment which is associated with at least one mobile device. For example, the game organizer receives a payment if the player uses a mobile phone. For example, the game organizer receives a payment if the player uses a tablet. The payment can come from a company which is associated with the mobile device. For example, the payment can come from a casino, a hotel, a gaming company, a television company, a producer, a distributor, and any type of company.

In one embodiment, the game organizer receives a payment which is associated with at least one investor. For example, the game organizer receives a payment from shareholders. For example, the game organizer receives a payment associated with venture capital. For example, the game organizer receives a payment from online investors.

In one embodiment, the game is totally free for the player and the game organizer receives a payment from at least one other source than the player. For example, the first, second, and third payment from the player are equal to zero and the game organizer receives at least one payment from one of the sources described in the preceding paragraphs.

In one embodiment, the game is not totally free for the player and the game organizer receives a payment from at least one other source than the player. For example, the first, or the second, or the third payment from the player are different from zero and the game organizer receives at least one payment from one of the sources described in the preceding paragraphs.

### Financial Disclosure—Part Two

On the one hand, many mutual funds collect money from private savers to invest it globally on financial markets. In this first case, the savers are integrated but passive. Money management is delegated by the savers to the mutual funds. The savers have just the possibility to stay in the funds or to leave. On the other hand, many individual investors buy directly financial products listed on organized markets, like Wall Street. In this second case, the savers are active but isolated. Money management is done by the savers themselves.

Disclosure is made of a new type of mutual fund where investors can choose themselves permanently the financial products that they want to buy, to hold or to sell. Namely, the investors every day have the possibility to buy or sell stocks, bonds or derivative products like trackers and others, among a large (but limited) list of products. In particular, the investors every day have the possibility to buy or sell financial products which are listed or quoted on organized markets, like Wall Street. The large (but limited) list of products can comprise at least one of the following: the most common financial products, the most frequently traded products, the products with the highest trading volumes or values, products selected for their potential, products selected by experts, products selected by the fund, products permanently comprised in the list, and products comprised in the list on a non-permanent basis.

The advantage of this kind of fund for the savers is not the opportunity to profit from the skill and knowledge of the fund manager for the choice of promising assets. The advantage is to simplify direct investing and to reduce considerably the transaction costs for the individual investors, and namely for the most active individual investors.

Inside the fund, the settlement or clearing of buying and selling orders can be done, for example, each day at the same time based on the prices or quotes publicly listed on markets. The global costs of transactions for the fund are reduced by the internal compensation between buying and selling orders and so limited to the balance. So the individual investors can enjoy reduced costs and make an active trading.

This is different from existing “funds of funds” which enable savers to choose the composition of their assets between different specialized managed funds hold by a global fund. For example, the savers must choose between different funds proposed and managed by Fidelity. As money management is systematically delegated at some stage, the savers cannot use the fund to buy themselves, for example, Apple and Google stocks and sell them with profit, for example, a few days later. The same goes for existing “open architecture” money management.

We claim:

1. A method comprising: causing a processor to execute a plurality of instructions stored on at least one memory device to:
(a) enable at least one player to have an account wherein:
(i) the account is associated with the at least one player,
(ii) the at least one player is enabled to accumulate points on the account, and
(iii) the at least one player is granted a first number of points when the account is created, wherein:
(iiia) the first number of points is associated with the at least one player,
(iiib) the first number of points is either (iiibi) equal to zero, or (iiibii) different from zero, and
(iiic) the first number of points is accumulated on the account,
(b) determine at least one game, including:
(i) determine a first plurality of periods wherein the first plurality of periods is associated with the at least one game,
(ii) enable the at least one player to have at least one participation in the at least one game for at least one period of the first plurality of periods, said the at least one participation, wherein:
(iia) the at least one participation is associated with:
(iiai) the at least one player,
(iiaii) the at least one game,
(iiaiii) the at least one period of the first plurality of periods, and
(iiaiv) a first wager wherein the first wager is either (iiaiva) equal to zero, or (iiaivb) greater than zero, and
(iib) the at least one player is granted a second number of points if the at least one participation is received from the at least one player, wherein:
(iibi) the second number of points is associated with the at least one player,
(iibii) the second number of points is either (iibiia) equal to zero, or (iibiib) different from zero, and
(iibiii) the second number of points is accumulated on the account, and
(iii) if the at least one participation is received from the at least one player, determine if the at least one participation is associated with at least one prize, wherein:
(iiia) the at least one prize comprise a third number of points, wherein:
(iiiai) the third number of points is associated with the at least one player,
(iiiaii) the third number of points is either (iiiaiia) equal to zero, or (iiiaiib) different from zero, and
(iiiaiii) the third number of points is accumulated on the account, and
(iiib) if the determination is that the at least one prize is associated with the at least one participation, provide the at least one prize to the at least one player,
(c) determine a second plurality of periods,
(d) determine at least one category,
(e) determine at least one promotional offer, including:
(i) include in each of the at least one promotional offer a plurality of advantages to be offered, said the plurality of advantages, and
(ii) for each of the at least one promotional offer:
(iia) associate each advantage of the plurality of advantages with the at least one promotional offer,
(iib) associate each advantage of the plurality of advantages with the same at least one of the at least one category, and
(iic) associate the plurality of advantages with the second plurality of periods, wherein:
(iici) each advantage of the plurality of advantages is associated with at least one period of the second plurality of periods, and
(iicii) at least two periods of the second plurality of periods are associated with at least one advantage of the plurality of advantages, and
(f) for at least one period of the second plurality of periods:
(i) enable the at least one player to make at least one request wherein:
(ia) the at least one request is associated with at least one of the at least one category,
(ib) the at least one request is associated with the at least one period of the plurality of periods,
(ic) the at least one request is associated with a fourth number of points, wherein
(ici) the fourth number of points is either (icia) equal to zero, or (icib) different from zero, and
(icii) the fourth number of points is accumulated on the account, and
(id) the at least one request is associated with a first payment wherein the first payment is either (idi) equal to zero, or (idii) greater than zero, said the request,
(ii) make a first determination, wherein the first determination is to determine if the request is received from the at least one player,
(iii) if the first determination is true, make a second determination wherein the second determination is to determine if at least one advantage of the plurality of advantages included in each of the at least one promotional offer is:
(iiia) associated with the at least one period of the plurality of periods which is associated with the request, and
(iiib) associated with the at least one of the at least one category which is associated with the request, and
(iv) if the second determination is true:
(iva) determine the at least one advantage of the plurality of advantages included in each of the at least one promotional offer which is associated with: (ivai) the at least one period of the plurality of periods which is associated with the request, and (ivaii) the at least one of the at least one category which is associated with the request, said the at least one available advantage,
(ivb) determine a number of the points accumulated on the account wherein:
(ivbi) the number of the points accumulated on the account is associated with the at least one player, and
(ivbii) the number of the points accumulated on the account is based at least on:
(ivbiia) the first number of points,
(ivbiib) the second number of points,
(ivbiic) the third number of points, and
(ivbiid) the fourth number of points,
(ivc) make a third determination wherein the third determination is to determine if the request is associated with the at least one available advantage based at least on the number of the points accumulated on the account, and
(ivd) if the third determination is true, provide the at least one available advantage to the at least one player and either (ivdi) maintain the number of the points accumulated on the account, or (ivdii) change the number of the points accumulated on the account to an other number of the points accumulated on the account.

2. The method of claim 1, wherein at least one of:
(i) the at least one game is a game of pure chance,
(ii) the at least one game has a part of chance,
(iii) the at least one game is a game of mixed chance and skill,
(iv) the at least one game is a lottery game,
(v) the at least one game is a forecasting game,
(vi) the at least one game is a financial game,
(vii) the at least one game is a financial forecasting game,
(viii) the at least one game is a betting game,
(ix) the at least one game is a sports game,
(x) the at least one game is a game with questions,
(xi) the at least one game is a quizz,
(xii) the at least game is a skill game,
(xiii) the at least game has a part of skill,
(xiv) the at least game is a game of knowledge, and
(xv) the at least game has a part of knowledge.

3. The method of claim 1, wherein at least one of:
(a) the first plurality of periods and the second plurality of periods are the same or different,
(b) at least one period of the first plurality of periods and at least one the second plurality of periods are the same or different,
(c) the at least one game and the at least one promotional offer can be accessed on the same or different devices,
(d) the at least one game and the at least one promotional offer can be accessed at a same or different times, and
(e) the at least one game or the at least one promotional offer can be accessed with a touchscreen.

4. The method of claim 1, further comprising at least one of:
(a) the third determination is based at least on a ranking of the at least one player, wherein the ranking of the at least one player is based at least on the number of the points accumulated on the account,
(b) the third determination is based at least on a scoring of the at least one player, wherein the scoring of the at least one player is based at least on the number of the points accumulated on the account,
(c) the number of the points accumulated on the account associated with the at least one player can be transferred to another different account associated with another different at least one player either (i) in part, or (ii) in totality, and
(d) change the third determination to be based at least on a chosen number of points, wherein the chosen number of points is (i) lower than the number of the points accumulated on the account, and (ii) determined by the at least one player.

5. The method of claim 1, further comprising: causing the processor to execute a plurality of instructions stored on at least one memory device to:
(a) receive the at least one request from the at least one player,
(b) receive at least one second request from the at least one player, wherein the at least one second request from the at least one user is:
(i) associated with a second at least one of the at least one category, wherein the second at least one of the at least one category is either (ia) the same at least one of the at least one category which is associated with the request, or (ib) a different at least one of the at least one category from the at least one of the at least one category which is associated with the request,
(ii) associated with a second at least one period of the second plurality of periods, wherein the second at least one period of the second plurality of periods is either (iia) the same at least one period of the second plurality of periods which is associated with the request, or (iib) a different at least one period of the second plurality of periods from the at least one period of the second plurality of periods which is associated with the request,
(iii) associated with a fifth number of points, wherein the fifth number of points is either (iiia) equal to zero, or (iiib) different from zero, and (iv) associated with a second payment wherein the second payment is either (iva) equal to zero, or (ivb) greater than zero, said the second request,
(c) make a fifth determination wherein the fifth determination is to determine if a second at least one advantage of the second plurality of advantages included in each of the at least one promotional offer is: (ci) associated with the second at least one period of the second plurality of periods associated with the second request, and (cii) associated with the second at least one of the at least one category associated with the second request, and
(d) if the fifth determination is true:
(i) determine the second at least one advantage of the plurality of advantages included in each of the at least one promotional offer which is associated with:
(ia) the second at least one period of the second plurality of periods associated with the second request, and
(ib) the second at least one of the at least one category associated with the second request, said the second at least one available advantage,
(ii) determine a second number of the points accumulated on the account wherein:
(iia) the second number of the points accumulated on the account is associated with the at least one player, and
(iib) the second number of the points accumulated on the account is based at least on:
(iibi) either (iibia) the number of the points, or (iibib) the other number of the points, and
(iibii) the fifth number of points,
(iii) make a sixth determination wherein the sixth determination is to determine if the second request is associated with the second at least one available advantage based at least on the second number of the points accumulated on the account, and
(iv) if the sixth determination is true, provide the second at least one available advantage to the at least one player and either (iva) maintain the second number of the points accumulated on the account, or (ivb) change the second number of the points accumulated on the account to an other second number of the points accumulated on the account.

6. The method of claim 1, further comprising: causing the processor to execute a plurality of instructions stored on at least one memory device to:
(a) determine a third plurality of periods wherein the third plurality of periods and the first plurality of periods are either (i) the same, or (ii) different,
(b) determine at least one second game, wherein: (i) the at least one game is associated with the third plurality of periods, and (ii) the at least one second game and the at least one game are either (i) the same, or (ii) different,
(c) enable the at least one player to have at least one second participation from the at least one player in the at least one second game for at least one second period of the third plurality of periods, wherein:
(i) the at least one period of the first plurality of periods for which the at least one participation in the at least one game is received from the at least one player and the at least one second period of the third plurality of periods for which the at least one second participation is received from the at least one player in the at least one second game are either (ia) the same, or (ib) different, and
(ii) the at least one game wherein the at least one participation is received from the at least one player for the at least one period of the first plurality of periods and the at least one second game wherein the at least one second participation is received from the at least one player for the at least second period of the third plurality of periods are either (iia) the same, or (iib) different,
(iii) the at least one second participation is associated with:
(iiia) the at least one player,
(iiib) the at least one second game,
(iiic) the at least one second period of the third plurality of periods, and
(iiid) a second wager wherein the second wager is either (iiidi) equal to zero, or (iiidii) greater than zero,
(iv) the at least one player is granted a fifth number of points if the at least one second participation is received from the at least one player, wherein:
(iva) the fifth number of points is associated with the at least one player,
(ivb) the fifth number of points is either (ivbi) equal to zero, or (ivbii) different from zero, and
(ivc) the fifth number of points is accumulated on the account, and
(v) if the at least one second participation is received from the at least one player, determine if the at least one second participation is associated with at least one second prize, wherein:
(va) the at least one second prize comprise a sixth number of points, wherein:
(vai) the sixth number of points is associated with the at least one player,
(vaii) the sixth number of points is either (vaiia) equal to zero, or
(vaiib) different from zero, and
(vaiii) the sixth number of points is accumulated on the account, and
(vb) if the determination is that the at least one second prize is associated with the at least one second participation, provide the at least one second prize to the at least one player, and
(d) change the determination of the number of the points accumulated on the account to be based at least on: (i) the first number of points, (ii) the second number of points, (iii) the third number of points, (iv) the fourth number of points, (v) the fifth number of points, and (vi) the sixth number of points.

7. The method of claim 5, wherein at least one of:
(a) the fourth number of points associated with the at least one request from the at least one player and the fifth number of points associated with the at least one second request from the at least one player are the same or different,
(b) the fourth number of points associated with the at least one request from the at least one player and the fifth number of points associated with the at least one second request from the at least one player are the same or different wherein: (i) the at least one period of the second plurality of periods which is associated with the at least one request from the at least one player, and (ii) the second at least one period of the second plurality of periods which is associated with the at least one second request from the at least one player, are the same or different,
(c) the fourth number of points associated with the at least one request from the at least one player and the fifth number of points associated with a at least one second request from the at least one player are the same or different wherein: (i) the at least one category which is associated with at least one request from the at least one player, and (ii) the second at least one category which is associated with the at least one second request from the at least one player, are the same or different, and
(d) the fifth number of points associated with the at least one second request from the at least one player is greater than the fourth number of points associated with the at least one request from the at least one player wherein: the second at least one period of the second plurality of periods which is associated with the at least one second request from the at least one player is later than the at least one period of the second plurality of periods which is associated with the at least one request from the at least one player.

8. The method of claim 6, wherein at least one of:
(a) the second number of points associated with the at least one participation from the at least one player and the fifth number of points associated with the at least one second participation from the at least one player are the same or different,
(b) the third number of points associated with the at least one participation from the at least one player and the sixth number of points associated with the at least one second participation from the at least one player are the same or different,
(c) the second number of points associated with the at least one participation from the at least one player and the fifth number of points associated with the at least one second participation from the at least one player are the same or different, wherein: (i) the at least one period of the first plurality of periods which is associated with the at least one participation from the at least one player, and (ii) the at least one period of the third plurality of periods which is associated with the at least one second participation from the at least one player, are the same or different,
(d) the second number of points associated with the at least one participation from the at least one player and the fifth number of points associated with the at least one second participation from the at least one player are the same or different, wherein: (i) the at least one game which is associated with the at least one participation from the at least one player, and (ii) the at least one second game which is associated with the at least one second participation from the at least one player, are the same or different,
(e) the third number of points associated with the at least one participation from the at least one player and the sixth number of points associated with the at least one second participation from the at least one player are the same or different, wherein: (i) the at least one period of the first plurality of periods which is associated with the at least one participation from the at least one player, and (ii) the at least one period of the third plurality of periods which is associated with the at least one second participation from the at least one player, are the same or different, and
(f) the third number of points associated with the at least one participation from the at least one player and the sixth number of points associated with the at least one second participation from the at least one player are the same or different, wherein: (i) the at least one game which is associated with the at least one participation from the at least one player, and (ii) the at least one second game which is associated with the at least one second participation from the at least one player, are the same or different.

9. The method of claim 1, wherein at least one of:
(a) at least one of: (I) during the second plurality of periods the at least one player is provided, (II) during each period of the second plurality of periods the at least one player is provided, (III) during at least one of the each period of the second plurality of periods the at least one player is provided, (IV) during each period of the second plurality of periods the request is associated, and (V) during at least one of the each period of the second plurality of periods the request is associated, with at least one of: (i) zero advantage, (ii) one advantage, and (iii) more than one advantage,
(b) at least one of: (I) during the second plurality of periods the plurality of advantages in at least one of the at least one promotional offer to be offered, (II) during the second plurality of periods the plurality of advantages in each of the at least one promotional offer to be offered, (III) during each period of the second plurality of periods the at least one available advantage, and (IV) during at least one of the each period of the second plurality of periods the at least one available advantage, is at least one of: (i) totally attributed, (ii) partially attributed, and (iii) with zero attribution,
(c) each period of the second plurality of periods has a same or different duration, and
(d) at least two of the each period of the second plurality of periods have a same or different duration.

10. The method of claim 1, wherein at least one of:
(a) the at least one category is at least one of: (i) a product, (ii) a service, (iii) a shop, (iv) a website, (v) a category of products, (vi) a category of services, (vii) a category of shops, (viii) a category of web sites, (ix) including at least one product, (x) including at least one service, (xi) including at least one shop, (xii) including at least one website, (xiii) a plurality of products, (xiv) a plurality of services, (xv) a plurality of shops, and (xvi) a plurality of websites,
(b) at least one of: (I) each advantage of the plurality of advantages, (II) at least one of the each advantage of the plurality of advantages, (III) each of the at least one promotional offer, and (IV) at least one of the at least one promotional offer, is at least one of: (i) associated with a product, (ii) associated with a service, (iii) associated with a shop, (iv) associated with a website, (v) associated with a category of products, (vi) associated with a category of services, (vii) associated with a category of shops, (viii) associated with a category of websites, (ix) associated with a plurality of products, (x) associated with a plurality of services, (xi) associated with a plurality of shops, and (xii) associated with a plurality of websites,
(c) each advantage of the plurality of advantages is the same or different, and
(d) at least two of the each advantage of the plurality of advantages are the same or different.

11. The method of claim 1, wherein at least one of:
(a) at least one of: (i) the first determination, (ii) the second determination, and (iii) the third determination, is true or false,
(b) the second or third determination is an instant determination,
(c) the third determination is based at least on at least one of: (i) a ranking, (ii) random, (iii) skill, (iv) skill with a part of chance, (v) time, (vi) the moment of the request, (vii) points, (viii) a number of points, (ix) fidelity, (x) individual criteria, (xi) name, (xii) birth, (xiii) money, (xiv) fortune, (xv) revenue, (xvi) an event, (xvii) the outcome of an event, (xviii) knowledge, and (xix) a game,
(d) the third determination is at least one of: (i) done at the end of the at least one period of the plurality of periods, (ii) done during the at least one period of the plurality of periods, and (iii) done at the end of the plurality of periods,
(e) at least one of: (I) the third determination is based at least on a number of points, (II) the third determination is based at least on the moment of the request, (III) the third determination is done at the end of the at least one period of the plurality of periods, (IV) the third determination is done during the at least one period of the plurality of periods, (V) the third determination is done at the end of the plurality of periods, (VI) the third determination is based at least on a ranking, and (VII) the third determination is based at least on time, and at least one of: (i) the at least one player is provided with zero available advantage, (ii) the at least one player is provided with one available advantage, (iii) the at least one player is provided with more than one available advantage, (iv) zero available advantage is provided, (v) one available advantage is provided, (vi) more than one available advantage is provided, and (vii) at least two players are provided with at least one available advantage, and
(f) the third determination is based at least on at least one number of points wherein the calculation of the at least one number of points comprise at least one of: (i) points granted in at least one game, (ii) points granted for fidelity, (iii) points associated with the at least one request, and (iv) points associated with the at least one request and points granted in at least one game.

12. The method of claim 1, further comprising at least one of:
(a) the at least one promotional offer is associated with at least one game, wherein the third determination to determine if the request is associated with the at least one available advantage is based at least on the at least one game, and wherein at least one of: (i) the at least one game is a game of pure chance, (ii) the at least one game has a part of chance, (iii) the at least one game is a game of mixed chance and skill, (iv) the at least one game is a lottery game, (v) the at least one game is a forecasting game, (vi) the at least one game is a financial game, (vii) the at least one game is a financial forecasting game, (viii) the at least one game is a betting game, (ix) the at least one game is a sports game, (x) the at least one game is a game with questions, (xi) the at least one game is a quizz, (xii) the at least game is a skill game, (xiii) the at least game has a part of skill, (xiv) the at least game is a game of knowledge, and (xv) the at least game has a part of knowledge, and
(b) the at least one promotional offer is associated with at least one event, wherein the third determination to determine if the request is associated with the at least one available advantage is based at least on the outcome of the at least one event, and the at least one event is at least one of: (i) an event associated with the at least one player, (ii) an event associated with a shop, (iii) an event associated with money, (iv) an event associated with a number, (y) an event associated with a result, and (vi) an event associated with sports.

13. The method of claim 1, further comprising at least one of:
(a) receive at least one second payment from at least one other source than the at least one player, wherein the at least one second payment is associated with: (i) advertising, (ii) selling data, (iii) sponsoring, (iv) selling a service, (v) selling a product, (vi) at least one device, (vii) at least one mobile device, and (viii) at least one investor,
(b) build databases with collected data,
(c) sell data associated with the at least one player,
(d) after the second determination use links to websites or mobile sites, and
(e) use links to websites or mobile sites.

14. The method of claim 1, wherein the at least one player is located in a determined shop when he makes the request and at least one of:
(a) the at least one category comprises items sold in the determined shop,
(b) the at least one category is at least one of: (i) a product, (ii) a service, (iii) a shop, (iv) a website, (v) a category of products, (vi) a category of services, (vii) a category of shops, (viii) a category of websites, (ix) including at least one product, (x) including at least one service, (xi) including at least one shop, (xii) including at least one website, (xiii) a plurality of products, (xiv) a plurality of services, (xv) a plurality of shops, and (xvi) a plurality of websites, and
(c) at least one of: (I) each advantage of the plurality of advantages, (H) at least one of the each advantage of the plurality of advantages, (III) each of the at least one promotional offer, and (IV) at least one of the at least one promotional offer, is at least one of: (i) associated with a product, (ii) associated with a service, (iii) associated with a shop, (iv) associated with a website, (v) associated with a category of products, (vi) associated with a category of services, (vii) associated with a category of shops, (viii) associated with a category of websites, (ix) associated with a plurality of products, (x) associated with a plurality of services, (xi) associated with a plurality of shops, and (xii) associated with a plurality of websites.

15. The method of claim 1, further comprising: causing a processor to execute a plurality of instructions stored on at least one memory device to:
(a) determine a time in the at least one period of the plurality of periods, and
(b) if the time is determined in the at least one period of the plurality of periods:
(i) cancel the third determination,
(ii) if the second determination is true, make a fourth determination wherein the fourth determination is to determine if:
(iia) the request is associated with the at least one available advantage, and
(iib) the request is received after the determined time in the at least one period of the plurality of periods, and
(iii) if the fourth determination is true, provide the at least one available advantage to the at least one player.

16. The method of claim 1, further comprising:
(a) determine at least one supplier wherein the at least one supplier is associate with the at least one category, and
(b) contact at least one of each of the at least one supplier associated with the at least one category wherein at least one of:
(i) at least one of each of the at least one supplier associated with the at least one category is invited to make a business offer to the at least one player,
(ii) at least one of each of the at least one supplier associated with the at least one category is invited to make a business offer to the at least one player wherein the business offer to the at least one player is associated with a quantity,
(iii) at least one of each of the at least one supplier associated with the at least one category makes a business transaction with the at least one player,
(iv) at least one of each of the at least one supplier associated with the at least one category makes a business transaction with the at least one player wherein the business transaction with the at least one player is associated with a quantity, and
(v) at least one of each of the at least one supplier associated with the at least one category is invited to use collected data from the at least one player.

17. The method of claim 1, further comprising:
(a) include in at least one of the at least one promotional offer a plurality of items to be sold, said the plurality of items, wherein:
(i) the plurality of items is associated with the plurality of advantages included in the at least one of the at least one promotional offer,
(ii) each of the items of the plurality of items is at least one of: (iia) a product, (iib) a service, (iic) a plurality of products, (iid) a plurality of services, and (iie) a plurality of products and services,
(iii) each item of the plurality of items is associated with each advantage of the plurality of advantages included in the at least one of the at least one promotional offer, and
(b) if the third determination is true:
(i) determine if the at least one available advantage is associated with the at least one of the at least one promotional offer,
(ii) if the determination is that the at least one available advantage is associated with the at least one of the at least one promotional offer, determine the item of the plurality of items which is associated with the at least one available advantage, said the promoted item, and
(iii) if the at least one available advantage is provided to the at least one user, sell the promoted item to the at least one user.

18. A method comprising: causing a processor to execute a plurality of instructions stored on at least one memory device to:
(a) determine a plurality of periods,
(b) determine at least one category,
(c) determine at least one promotional offer, including:
(i) include in each of the at least one promotional offer a plurality of advantages to be offered, said the plurality of advantages, and
(ii) for each of the at least one promotional offer:
(iia) associate each advantage of the plurality of advantages with the at least one promotional offer,
(iib) associate each advantage of the plurality of advantages with the same at least one of the at least one category, and
(iic) associate the plurality of advantages with the plurality of periods, wherein:
(iici) each advantage of the plurality of advantages is associated with at least one period of the plurality of periods, and
(iicii) at least two periods of the plurality of periods are associated with at least one advantage of the plurality of advantages, and
(d) for at least one period of the plurality of periods:
(i) enable the at least one user to make at least one request wherein:
(ia) the at least one request is associated with at least one of the at least one category,
(ib) the at least one request is associated with the at least one period of the plurality of periods, and
(ic) the at least one request is associated with a first payment wherein the first payment is either (ici) equal to zero, or (icii) greater than zero, said the request,
(ii) make a first determination, wherein the first determination is to determine if the request is received from the at least one user,
(iii) if the first determination is true, make a second determination wherein the second determination is to determine if at least one advantage of the plurality of advantages included in each of the at least one promotional offer is:
(iiia) associated with the at least one period of the plurality of periods which is associated with the request, and
(iiib) associated with the at least one of the at least one category which is associated with the request, and
(iv) if the second determination is true:
(iva) determine the at least one advantage of the plurality of advantages included in each of the at least one promotional offer which is associated with: (ivai) the at least one period of the plurality of periods which is associated with the request, and (ivaii) the at least one of the at least one category which is associated with the request, said the at least one available advantage,
(ivb) make a third determination wherein the third determination is to determine if the request is associated with the at least one available advantage, and
(ivc) if the third determination is true, provide the at least one available advantage to the at least one user.

19. The method of claim 18, further comprising: causing the processor to execute a plurality of instructions stored on at least one memory device to:
(a) enable at least one user to have an account wherein:
(i) the account is associated with the at least one user,
(ii) the at least one user is enabled to accumulate points on the account, and
(iii) the at least one user is granted a first number of points when the account is created, wherein:
(iiia) the first number of points is associated with the at least one user,
(iiib) the first number of points is either (iiibi) equal to zero, or (iiibii) different from zero, and
(iiic) the first number of points is accumulated on the account,
(b) associate the at least one request with a second number of points, wherein
(i) the second number of points is either (ia) equal to zero, or (ib) different from zero, and
(ii) the second number of points is accumulated on the account, and
(c) if the second determination is true:
(i) determine a number of the points accumulated on the account wherein:
(ia) the number of the points accumulated on the account is associated with the at least one user, and
(ib) the number of the points accumulated on the account is based at least on:
(ibi) the first number of points, and
(ibii) the second number of points,
(ii) base the third determination on the number of the points accumulated on the account, and
(iii) if the third determination is true, either (iiia) maintain the number of the points accumulated on the account, or (iiib) change the number of the points accumulated on the account to an other number of the points accumulated on the account.

20. The method of claim 19, further comprising at least one of:
(a) the third determination is based at least on a ranking of the at least one user, wherein the ranking of the at least one user is based at least on the number of the points accumulated on the account,
(b) the third determination is based at least on a scoring of the at least one user, wherein the scoring of the at least one user is based at least on the number of the points accumulated on the account,
(c) the number of the points accumulated on the account associated with the at least one user can be transferred to another different account associated with another different at least one user either (i) in part, or (ii) in totality, and
(d) change the third determination to be based at least on a chosen number of points, wherein the chosen number of points is (i) lower than the number of the points accumulated on the account, and (ii) determined by the at least one user.

21. The method of claim 19, further comprising: causing the processor to execute a plurality of instructions stored on at least one memory device to:
(a) receive the at least one request from the at least one user,
(b) receive at least one second request from the at least one user, wherein the at least one second request from the at least one user is:
(i) associated with a second at least one of the at least one category, wherein the second at least one of the at least one category is either (ia) the same at least one of the at least one category which is associated with the request, or (ib) a different at least one of the at least one category from the at least one of the at least one category which is associated with the request,
(ii) associated with a second at least one period of the plurality of periods, wherein the second at least one period of the plurality of periods is either (iia) the same at least one period of the plurality of periods which is associated with the request, or (iib) a different at least one period of the plurality of periods from the at least one period of the plurality of periods which is associated with the request,
(iii) associated with a third number of points, wherein:
(iiia) the third number of points is either (iiiai) equal to zero, or (iiiaii) different from zero, and
(iiib) the third number of points is accumulated on the account, and
(iv) associated with a second payment wherein the second payment is either
(iva) equal to zero, or (ivb) greater than zero, said the second request,
(c) make a fourth determination wherein the fourth determination is to determine if a second at least one advantage of the plurality of advantages included in each of the at least one promotional offer is: (i) associated with the second at least one period of the plurality of periods associated with the second request, and (ii) associated with the second at least one of the at least one category associated with the second request, and
(d) if the fourth determination is true:
(i) determine the second at least one advantage of the plurality of advantages included in each of the at least one promotional offer which is associated with:
(ia) the second at least one period of the plurality of periods associated with the second request, and
(ib) the second at least one of the at least one category associated with the second request, said the second at least one available advantage,
(ii) determine a second number of the points accumulated on the account wherein:
(iia) the second number of the points accumulated on the account is associated with the at least one user, and
(iib) the second number of the points accumulated on the account is based at least on:
(iibi) either (iibia) the number of the points, or (iibib) the other number of the points, and
(iibii) the third number of points,
(iii) make a fifth determination wherein the fifth determination is to determine if the second request is associated with the second at least one available advantage based at least on the second number of the points accumulated on the account, and
(iv) if the fifth determination is true, provide the second at least one available advantage to the at least one user and either (iva) maintain the second number of the points accumulated on the account, or (ivb) change the second number of the points accumulated on the account to an other second number of the points accumulated on the account.

22. The method of claim 21, wherein at least one of:
(a) the second number of points associated with the at least one request from the at least one user and the third number of points associated with the at least one second request from the at least one user are the same or different,
(b) the second number of points associated with the at least one request from the at least one user and the third number of points associated with the at least one second request from the at least one user are the same or different wherein: (i) the at least one period of the plurality of periods which is associated with the at least one request from the at least one user, and (ii) the second at least one period of the plurality of periods which is associated with the at least one second request from the at least one user, are the same or different,
(c) the second number of points associated with the at least one request from the at least one user and the third number of points associated with a at least one second request from the at least one user are the same or different wherein: (i) the at least one category which is associated with at least one request from the at least one user, and (ii) the second at least one category which is associated with the at least one second request from the at least one user, are the same or different, and
(d) the third number of points associated with the at least one second request from the at least one user is greater than the second number of points associated with the at least one request from the at least one user wherein: the second at least one period of the plurality of periods which is associated with the at least one second request from the at least one user is later than the at least one period of the plurality of periods which is associated with the at least one request from the at least one user.

23. The method of claim 19, further comprising: causing the processor to execute a plurality of instructions stored on at least one memory device to:
(a) enable at least one second different user to have a second account wherein:
(i) the second account is associated with the at least one second different user,
(ii) the at least one second different user is enabled to accumulate points on the second account, and
(iii) the at least one second different user is granted a third number of points when the second account is created, wherein:
(iiia) the third number of points is associated with the at least one user,
(iiib) the third number of points is either (iiibi) equal to zero, or (iiibii) different from zero, and
(iiic) the third number of points is accumulated on the second account,
(b) receive a second at least one request from the at least one second different user, wherein the second at least one request from the at least one second different user is:
(i) associated with a second at least one of the at least one category, wherein the second at least one of the at least one category is either (ia) the same at least one of the at least one category which is associated with the request, or (ib) a different at least one of the at least one category from the at least one of the at least one category which is associated with the request,
(ii) associated with a second at least one period of the plurality of periods, wherein the second at least one period of the plurality of periods is either (iia) the same at least one period of the plurality of periods which is associated with the request, or (iib) a different at least one period of the plurality of periods from the at least one period of the plurality of periods which is associated with the request,
(iii) associated with a third number of points, wherein:
(iiia) the third number of points is either (iiiai) equal to zero, or (iiiaii) different from zero, and
(iiib) the third number of points is accumulated on the second account, and
(iv) associated with a second payment wherein the second payment is either (iva) equal to zero, or (ivb) greater than zero, said the second request,
(c) make a fourth determination wherein the fourth determination is to determine if a second at least one advantage of the plurality of advantages included in each of the at least one promotional offer is: (ci) associated with the second at least one period of the plurality of periods associated with the second request, and (cii) associated with the second at least one of the at least one category associated with the second request, and
(d) if the fourth determination is true:
(di) determine the second at least one advantage of the plurality of advantages included in each of the at least one promotional offer which is associated with:
(dia) the second at least one period of the plurality of periods associated with the second request, and
(dib) the second at least one of the at least one category associated with the second request, said the second at least one available advantage,
(dii) determine a second number of the points accumulated on the second account wherein:
(diia) the second number of the points accumulated on the second account is associated with the at least one second different user, and
(diib) the second number of the points accumulated on the second account is based at least on:
(diibi) either (diibia) the number of the points, or (diibib) the other number of the points, and
(diibii) the third number of points,
(diii) make a fifth determination wherein the fifth determination is to determine if the second request is associated with the second at least one available advantage based at least on the second number of the points accumulated on the second account, and
(div) if the fifth determination is true, provide the second at least one available advantage to the at least one second different user and either (diva) maintain the second number of the points accumulated on the second account, or (divb) change the second number of the points accumulated on the second account to an other second number of the points accumulated on the second account.

24. The method of claim 23, wherein the second at least one request from the at least one second different user is: (i) associated with a second at least one of the at least one category, wherein the second at least one of the at least one category is the same at least one of the at least one category which is associated with the request, and (ii) associated with a second at least one period of the plurality of periods, wherein the second at least one period of the plurality of periods is either (iia) the same at least one period of the plurality of periods which is associated with the request, further comprising at least one of:
(a) the third determination is based at least on a ranking of the at least one user and the at least one second different user, wherein the ranking of the at least one user and the at least one second different user is based at least on: (i) the number of the points accumulated on the account, and (ii) the second number of the points accumulated on the second account, and
(b) the fifth determination is based at least on a ranking of the at least one user and the at least one second different user, wherein the ranking of the at least one user and the at least one second different user is based at least on: (i) the number of the points accumulated on the account, and (ii) the second number of the points accumulated on the second account.

25. The method of claim 23, wherein at least one of:
(a) the second number of points associated with the at least one request from the at least one user and the third number of points associated with the second at least one request from the at least one second different user are the same or different,
(b) the second number of points associated with the at least one request from the at least one user and the third number of points associated with the second at least one request from the at least one second different user are the same or different wherein: (i) the at least one period of the plurality of periods which is associated with the at least one request from the at least one user, and (ii) the second at least one period of the plurality of periods which is associated with the second at least one request from the at least one second different user are the same or different,
(c) the second number of points associated with the at least one request from the at least one user and the third number of points associated with the second at least one request from the at least one second different user are the same or different wherein: (i) the at least one category which is associated with at least one request from the at least one user, and (ii) the second at least one category which is associated with the second at least one request from the at least one second different user are the same or different, and
(d) the third number of points associated with the second at least one request from the at least one second different user is greater than the second number of points associated with the at least one request from the at least one user wherein: the second at least one period of the plurality of periods which is associated with the second at least one request from the at least one second different user is later than the at least one period of the plurality of periods which is associated with the at least one request from the at least one user.

26. The method of claim 18, wherein at least one of:
(a) at least one of: (I) during the plurality of periods the at least one user is provided, (II) during each period of the plurality of periods the at least one user is provided, (III) during at least one of the each period of the plurality of periods the at least one user is provided, (IV) during each period of the plurality of periods the request is associated, and (V) during at least one of the each period of the plurality of periods the request is associated, with at least one of: (i) zero advantage, (ii) one advantage, and (iii) more than one advantage,
(b) at least one of: (I) during the plurality of periods the plurality of advantages in at least one of the at least one promotional offer to be offered, (II) during the plurality of periods the plurality of advantages in each of the at least one promotional offer to be offered, (III) during each period of the plurality of periods the at least one available advantage, and (IV) during at least one of the each period of the plurality of periods the at least one available advantage, is at least one of: (i) totally attributed, (ii) partially attributed, and (iii) with zero attribution,
(c) each period of the plurality of periods has a same or different duration, and
(d) at least two of the each period of the plurality of periods have a same or different duration.

27. The method of claim 18, wherein at least one of:
(a) the at least one category is at least one of: (i) a product, (ii) a service, (iii) a shop, (iv) a website, (v) a category of products, (vi) a category of services, (vii) a category of shops, (viii) a category of websites, (ix) including at least one product, (x) including at least one service, (xi) including at least one shop, (xii) including at least one website, (xiii) a plurality of products, (xiv) a plurality of services, (xv) a plurality of shops, and (xvi) a plurality of websites,
(b) at least one of: (I) each advantage of the plurality of advantages, (II) at least one of the each advantage of the plurality of advantages, (III) each of the at least one promotional offer, and (IV) at least one of the at least one promotional offer, is at least one of: (i) associated with a product, (ii) associated with a service, (iii) associated with a shop, (iv) associated with a website, (v) associated with a category of products, (vi) associated with a category of services, (vii) associated with a category of shops, (viii) associated with a category of websites, (ix) associated with a plurality of products, (x) associated with a plurality of services, (xi) associated with a plurality of shops, and (xii) associated with a plurality of websites,
(c) each advantage of the plurality of advantages is the same or different, and
(d) at least two of the each advantage of the plurality of advantages are the same or different.

28. The method of claim 18, wherein at least one of:
(a) at least one of: (i) the first determination, (ii) the second determination, and (iii) the third determination, is true or false,
(b) the second or third determination is an instant determination,
(c) the third determination is based at least on at least one of: (i) a ranking, (ii) random, (iii) skill, (iv) skill with a part of chance, (v) time, (vi) the moment of the request, (vii) points, (viii) a number of points, (ix) fidelity, (x) individual criteria, (xi) name, (xii) birth, (xiii) money, (xiv) fortune, (xv) revenue, (xvi) an event, (xvii) the outcome of an event, (xviii) knowledge, and (xix) a game,
(d) the third determination is at least one of: (i) done at the end of the at least one period of the plurality of periods, (ii) done during the at least one period of the plurality of periods, and (iii) done at the end of the plurality of periods,
(e) at least one of: (I) the third determination is based at least on a number of points, (II) the third determination is based at least on the moment of the request, (III) the third determination is done at the end of the at least one period of the plurality of periods, (IV) the third determination is done during the at least one period of the plurality of periods, (V) the third determination is done at the end of the plurality of periods, (VI) the third determination is based at least on a ranking, and (VII) the third determination is based at least on time, and at least one of: (i) the at least one user is provided with zero available advantage, (ii) the at least one user is provided with one available advantage, (iii) the at least one user is provided with more than one available advantage, (iv) zero available advantage is provided, (v) one available advantage is provided, (vi) more than one available advantage is provided, and (vii) at least two users are provided with at least one available advantage, and
(f) the third determination is based at least on at least one number of points wherein the calculation of the at least one number of points comprise at least one of: (i) points granted in at least one game, (ii) points granted for fidelity, (iii) points associated with the at least one request, and (iv) points associated with the at least one request and points granted in at least one game.

29. The method of claim 18, further comprising at least one of:
(a) the at least one promotional offer is associated with at least one game, wherein the third determination to determine if the request is associated with the at least one available advantage is based at least on the at least one game, and wherein at least one of: (i) the at least one game is a game of pure chance, (ii) the at least one game has a part of chance, (iii) the at least one game is a game of mixed chance and skill, (iv) the at least one game is a lottery game, (v) the at least one game is a forecasting game, (vi) the at least one game is a financial game, (vii) the at least one game is a financial forecasting game, (viii) the at least one game is a betting game, (ix) the at least one game is a sports game, (x) the at least one game is a game with questions, (xi) the at least one game is a quizz, (xii) the at least game is a skill game, (xiii) the at least game has a part of skill, (xiv) the at least game is a game of knowledge, and (xv) the at least game has a part of knowledge, and
(b) the at least one promotional offer is associated with at least one event, wherein the third determination to determine if the request is associated with the at least one available advantage is based at least on the outcome of the at least one event, and the at least one event is at least one of: (i) an event associated with the at least one user, (ii) an event associated with a shop, (iii) an event associated with money, (iv) an event associated with a number, (v) an event associated with a result, and (vi) an event associated with sports.

30. The method of claim 18, further comprising at least one of:
(a) receive at least one second payment from at least one other source than the at least one user, wherein the at least one second payment is associated with: (i) advertising, (ii) selling data, (iii) sponsoring, (iv) selling a service, (v) selling a product, (vi) at least one device, (vii) at least one mobile device, and (viii) at least one investor,
(b) build databases with collected data,
(c) sell data associated with the at least one user,
(d) after the second determination use links to websites or mobile sites, and
(e) use links to websites or mobile sites.

31. The method of claim 18, wherein the at least one user is located in a determined shop when he makes the request and at least one of:
(a) the at least one category comprises items sold in the determined shop,
(b) the at least one category is at least one of: (i) a product, (ii) a service, (iii) a shop, (iv) a website, (v) a category of products, (vi) a category of services, (vii) a category of shops, (viii) a category of websites, (ix) including at least one product, (x) including at least one service, (xi) including at least one shop, (xii) including at least one website, (xiii) a plurality of products, (xiv) a plurality of services, (xv) a plurality of shops, and (xvi) a plurality of websites, and
(c) at least one of: (I) each advantage of the plurality of advantages, (II) at least one of the each advantage of the plurality of advantages, (HI) each of the at least one promotional offer, and (IV) at least one of the at least one promotional offer, is at least one of: (i) associated with a product, (ii) associated with a service, (iii) associated with a shop, (iv) associated with a website, (v) associated with a category of products, (vi) associated with a category of services, (vii) associated with a category of shops, (viii) associated with a category of websites, (ix) associated with a plurality of products, (x) associated with a plurality of services, (xi) associated with a plurality of shops, and (xii) associated with a plurality of websites.

32. The method of claim 18, further comprising: causing a processor to execute a plurality of instructions stored on at least one memory device to:
(a) determine a time in the at least one period of the plurality of periods, and
(b) if the time is determined in the at least one period of the plurality of periods:
(i) cancel the third determination,
(ii) if the second determination is true, make a fourth determination wherein the fourth determination is to determine if:
(iia) the request is associated with the at least one available advantage, and
(iib) the request is received after the determined time in the at least one period of the plurality of periods, and
(iii) if the fourth determination is true, provide the at least one available advantage to the at least one user.

33. The method of claim 18, further comprising:
(a) determine at least one supplier wherein the at least one supplier is associate with the at least one category, and
(b) contact at least one of each of the at least one supplier associated with the at least one category wherein at least one of:
(i) at least one of each of the at least one supplier associated with the at least one category is invited to make a business offer to the at least one user,
(ii) at least one of each of the at least one supplier associated with the at least one category is invited to make a business offer to the at least one user wherein the business offer to the at least one user is associated with a quantity,
(iii) at least one of each of the at least one supplier associated with the at least one category makes a business transaction with the at least one user,
(iv) at least one of each of the at least one supplier associated with the at least one category makes a business transaction with the at least one user wherein the business transaction with the at least one user is associated with a quantity, and
(v) at least one of each of the at least one supplier associated with the at least one category is invited to use collected data from the at least one user.

34. The method of claim 18, further comprising:
(a) include in at least one of the at least one promotional offer a plurality of items to be sold, said the plurality of items, wherein:
(i) the plurality of items is associated with the plurality of advantages included in the at least one of the at least one promotional offer,
(ii) each of the items of the plurality of items is at least one of: (iia) a product, (iib) a service, (iic) a plurality of products, (iid) a plurality of services, and (iie) a plurality of products and services,
(iii) each item of the plurality of items is associated with each advantage of the plurality of advantages included in the at least one of the at least one promotional offer, and
(b) if the third determination is true:
(i) determine if the at least one available advantage is associated with the at least one of the at least one promotional offer,
(ii) if the determination is that the at least one available advantage is associated with the at least one of the at least one promotional offer, determine the item of the plurality of items which is associated with the at least one available advantage, said the promoted item, and
(iii) if the at least one available advantage is provided to the at least one user, sell the promoted item to the at least one user.

35. A system comprising:
(i) at least one input device,
(ii) at least one display device,
(iii) a processor, and
(iv) at least one memory device which stores a plurality of instructions which when executed by the processor, cause the processor to operate with the one at least display device and the one at least input device to:
(a) determine a plurality of periods,
(b) determine at least one category,
(c) determine at least one promotional offer, including:
(i) include in each of the at least one promotional offer a plurality of advantages to be offered, said the plurality of advantages,
(ii) for each of the at least one promotional offer:
(iia) associate each advantage of the plurality of advantages with the at least one promotional offer,
(iib) associate each advantage of the plurality of advantages with the same at least one of the at least one category, and
(iic) associate the plurality of advantages with the plurality of periods, wherein:
(iici) each advantage of the plurality of advantages is associated with at least one period of the plurality of periods, and
(iicii) at least two periods of the plurality of periods are associated with at least one advantage of the plurality of advantages, and
(d) for at least one period of the plurality of periods:
(i) enable the at least one user to make at least one request wherein:
(ia) the at least one request is associated with at least one of the at least one category,
(ib) the at least one request is associated with the at least one period of the plurality of periods, and
(ic) the at least one request is associated with a first payment wherein the first payment is either (ici) equal to zero, or (icii) greater than zero, said the request,
(ii) make a first determination, wherein the first determination is to determine if the request is received from the at least one user,
(iii) if the first determination is true, make a second determination wherein the second determination is to determine if at least one advantage of the plurality of advantages included in each of the at least one promotional offer is:
(iiia) associated with the at least one period of the plurality of periods which is associated with the request, and
(iiib) associated with the at least one of the at least one category which is associated with the request, and
(iv) if the second determination is true:
(iva) determine the at least one advantage of the plurality of advantages included in each of the at least one promotional offer which is associated with: (ivai) the at least one period of the plurality of periods which is associated with the request, and (ivaii) the at least one of the at least one category which is associated with the request, said the at least one available advantage,
(ivb) make a third determination wherein the third determination is to determine if the request is associated with the at least one available advantage, and
(ivc) if the third determination is true, provide the at least one available advantage to the at least one user.

36. The system of claim 35, further comprising: causing the processor to execute a plurality of instructions stored on at least one memory device to:
(a) enable at least one user to have an account wherein:
(i) the account is associated with the at least one user,
(ii) the at least one user is enabled to accumulate points on the account, and
(iii) the at least one user is granted a first number of points when the account is created, wherein:
(iiia) the first number of points is associated with the at least one user,
(iiib) the first number of points is either (iiibi) equal to zero, or (iiibii) different from zero, and
(iiic) the first number of points is accumulated on the account,
(b) associate the at least one request with a second number of points, wherein
(i) the second number of points is either (ia) equal to zero, or (ib) different from zero, and
(ii) the second number of points is accumulated on the account, and
(c) if the second determination is true:
(i) determine a number of the points accumulated on the account wherein:
(ia) the number of the points accumulated on the account is associated with the at least one user, and
(ib) the number of the points accumulated on the account is based at least on:
(ibi) the first number of points, and
(ibii) the second number of points,
(ii) base the third determination on the number of the points accumulated on the account, and
(iii) if the third determination is true, either (iiia) maintain the number of the points accumulated on the account, or (iiib) change the number of the points accumulated on the account to an other number of the points accumulated on the account.

37. The system of claim 36, further comprising at least one of:
(a) the third determination is based at least on a ranking of the at least one user, wherein the ranking of the at least one user is based at least on the number of the points accumulated on the account,
(b) the third determination is based at least on a scoring of the at least one user, wherein the scoring of the at least one user is based at least on the number of the points accumulated on the account,
(c) the number of the points accumulated on the account associated with the at least one user can be transferred to another different account associated with another different at least one user either (i) in part, or (ii) in totality, and
(d) change the third determination to be based at least on a chosen number of points, wherein the chosen number of points is (i) lower than the number of the points accumulated on the account, and (ii) determined by the at least one user.

38. The system of claim 36, further comprising: causing the processor to execute a plurality of instructions stored on at least one memory device to:
(a) receive the at least one request from the at least one user,
(b) receive at least one second request from the at least one user, wherein the at least one second request from the at least one user is:
(i) associated with a second at least one of the at least one category, wherein the second at least one of the at least one category is either (ia) the same at least one of the at least one category which is associated with the request, or (ib) a different at least one of the at least one category from the at least one of the at least one category which is associated with the request,
(ii) associated with a second at least one period of the plurality of periods, wherein the second at least one period of the plurality of periods is either (iia) the same at least one period of the plurality of periods which is associated with the request, or (iib) a different at least one period of the plurality of periods from the at least one period of the plurality of periods which is associated with the request,
(iii) associated with a third number of points, wherein:
(iiia) the third number of points is either (iiiai) equal to zero, or (iiiaii) different from zero, and
(iiib) the third number of points is accumulated on the account, and
(iv) associated with a second payment wherein the second payment is either
(iva) equal to zero, or (ivb) greater than zero, said the second request,
(c) make a fourth determination wherein the fourth determination is to determine if a second at least one advantage of the plurality of advantages included in each of the at least one promotional offer is: (i) associated with the second at least one period of the plurality of periods associated with the second request, and (ii) associated with the second at least one of the at least one category associated with the second request, and
(d) if the fourth determination is true:
(i) determine the second at least one advantage of the plurality of advantages included in each of the at least one promotional offer which is associated with:
(ia) the second at least one period of the plurality of periods associated with the second request, and
(ib) the second at least one of the at least one category associated with the second request, said the second at least one available advantage,
(ii) determine a second number of the points accumulated on the account wherein:
(iia) the second number of the points accumulated on the account is associated with the at least one user, and
(iib) the second number of the points accumulated on the account is based at least on:
(iibi) either (iibia) the number of the points, or (iibib) the other number of the points, and
(iibii) the third number of points,
(iii) make a fifth determination wherein the fifth determination is to determine if the second request is associated with the second at least one available advantage based at least on the second number of the points accumulated on the account, and
(iv) if the fifth determination is true, provide the second at least one available advantage to the at least one user and either (iva) maintain the second number of the points accumulated on the account, or (ivb) change the second number of the points accumulated on the account to an other second number of the points accumulated on the account.

39. The system of claim 38, wherein at least one of:
(a) the second number of points associated with the at least one request from the at least one user and the third number of points associated with the at least one second request from the at least one user are the same or different,
(b) the second number of points associated with the at least one request from the at least one user and the third number of points associated with the at least one second request from the at least one user are the same or different wherein: (i) the at least one period of the plurality of periods which is associated with the at least one request from the at least one user, and (ii) the second at least one period of the plurality of periods which is associated with the at least one second request from the at least one user, are the same or different,
(c) the second number of points associated with the at least one request from the at least one user and the third number of points associated with a at least one second request from the at least one user are the same or different wherein: (i) the at least one category which is associated with at least one request from the at least one user, and (ii) the second at least one category which is associated with the at least one second request from the at least one user, are the same or different, and
(d) the third number of points associated with the at least one second request from the at least one user is greater than the second number of points associated with the at least one request from the at least one user wherein: the second at least one period of the plurality of periods which is associated with the at least one second request from the at least one user is later than the at least one period of the plurality of periods which is associated with the at least one request from the at least one user.

40. The system of claim 36, further comprising: causing the processor to execute a plurality of instructions stored on at least one memory device to:
(a) enable at least one second different user to have a second account wherein:
(i) the second account is associated with the at least one second different user,
(ii) the at least one second different user is enabled to accumulate points on the second account, and
(iii) the at least one second different user is granted a third number of points when the second account is created, wherein:
(iiia) the third number of points is associated with the at least one user,
(iiib) the third number of points is either (iiibi) equal to zero, or (iiibii) different from zero, and
(iiic) the third number of points is accumulated on the second account,
(b) receive a second at least one request from the at least one second different user, wherein the second at least one request from the at least one second different user is:
(i) associated with a second at least one of the at least one category, wherein the second at least one of the at least one category is either (ia) the same at least one of the at least one category which is associated with the request, or (ib) a different at least one of the at least one category from the at least one of the at least one category which is associated with the request,
(ii) associated with a second at least one period of the plurality of periods, wherein the second at least one period of the plurality of periods is either (iia) the same at least one period of the plurality of periods which is associated with the request, or (iib) a different at least one period of the plurality of periods from the at least one period of the plurality of periods which is associated with the request,
(iii) associated with a third number of points, wherein:
(iiia) the third number of points is either (iiiai) equal to zero, or (iiiaii) different from zero, and
(iiib) the third number of points is accumulated on the second account, and
(iv) associated with a second payment wherein the second payment is either (iva) equal to zero, or (ivb) greater than zero, said the second request,
(c) make a fourth determination wherein the fourth determination is to determine if a second at least one advantage of the plurality of advantages included in each of the at least one promotional offer is: (ci) associated with the second at least one period of the plurality of periods associated with the second request, and (cii) associated with the second at least one of the at least one category associated with the second request, and
(d) if the fourth determination is true:
(di) determine the second at least one advantage of the plurality of advantages included in each of the at least one promotional offer which is associated with:
(dia) the second at least one period of the plurality of periods associated with the second request, and
(dib) the second at least one of the at least one category associated with the second request, said the second at least one available advantage,
(dii) determine a second number of the points accumulated on the second account wherein:
(diia) the second number of the points accumulated on the second account is associated with the at least one second different user, and
(diib) the second number of the points accumulated on the second account is based at least on:
(diibi) either (diibia) the number of the points, or (diibib) the other number of the points, and
(diibii) the third number of points,
(diii) make a fifth determination wherein the fifth determination is to determine if the second request is associated with the second at least one available advantage based at least on the second number of the points accumulated on the second account, and
(div) if the fifth determination is true, provide the second at least one available advantage to the at least one second different user and either (diva) maintain the second number of the points accumulated on the second account, or (divb) change the second number of the points accumulated on the second account to an other second number of the points accumulated on the second account.

41. The system of claim 40, wherein the second at least one request from the at least one second different user is: (i) associated with a second at least one of the at least one category, wherein the second at least one of the at least one category is the same at least one of the at least one category which is associated with the request, and (ii) associated with a second at least one period of the plurality of periods, wherein the second at least one period of the plurality of periods is either (iia) the same at least one period of the plurality of periods which is associated with the request, further comprising at least one of:
(a) the third determination is based at least on a ranking of the at least one user and the at least one second different user, wherein the ranking of the at least one user and the at least one second different user is based at least on: (i) the number of the points accumulated on the account, and (ii) the second number of the points accumulated on the second account, and
(b) the fifth determination is based at least on a ranking of the at least one user and the at least one second different user, wherein the ranking of the at least one user and the at least one second different user is based at least on: (i) the number of the points accumulated on the account, and (ii) the second number of the points accumulated on the second account.

42. The system of claim 40, wherein at least one of:
(a) the second number of points associated with the at least one request from the at least one user and the third number of points associated with the second at least one request from the at least one second different user are the same or different,
(b) the second number of points associated with the at least one request from the at least one user and the third number of points associated with the second at least one request from the at least one second different user are the same or different wherein: (i) the at least one period of the plurality of periods which is associated with the at least one request from the at least one user, and (ii) the second at least one period of the plurality of periods which is associated with the second at least one request from the at least one second different user are the same or different,
(c) the second number of points associated with the at least one request from the at least one user and the third number of points associated with the second at least one request from the at least one second different user are the same or different wherein: (i) the at least one category which is associated with at least one request from the at least one user, and (ii) the second at least one category which is associated with the second at least one request from the at least one second different user are the same or different, and
(d) the third number of points associated with the second at least one request from the at least one second different user is greater than the second number of points associated with the at least one request from the at least one user wherein: the second at least one period of the plurality of periods which is associated with the second at least one request from the at least one second different user is later than the at least one period of the plurality of periods which is associated with the at least one request from the at least one user.

43. The system of claim 35, wherein at least one of:
(a) at least one of: (I) during the plurality of periods the at least one user is provided, (II) during each period of the plurality of periods the at least one user is provided, (III) during at least one of the each period of the plurality of periods the at least one user is provided, (IV) during each period of the plurality of periods the request is associated, and (V) during at least one of the each period of the plurality of periods the request is associated, with at least one of: (i) zero advantage, (ii) one advantage, and (iii) more than one advantage,
(b) at least one of: (I) during the plurality of periods the plurality of advantages in at least one of the at least one promotional offer to be offered, (II) during the plurality of periods the plurality of advantages in each of the at least one promotional offer to be offered, (III) during each period of the plurality of periods the at least one available advantage, and (IV) during at least one of the each period of the plurality of periods the at least one available advantage, is at least one of: (i) totally attributed, (ii) partially attributed, and (iii) with zero attribution,
(c) each period of the plurality of periods has a same or different duration, and
(d) at least two of the each period of the plurality of periods have a same or different duration.

44. The system of claim 35, wherein at least one of:
(a) the at least one category is at least one of: (i) a product, (ii) a service, (iii) a shop, (iv) a website, (v) a category of products, (vi) a category of services, (vii) a category of shops, (viii) a category of websites, (ix) including at least one product, (x) including at least one service, (xi) including at least one shop, (xii) including at least one website, (xiii) a plurality of products, (xiv) a plurality of services, (xv) a plurality of shops, and (xvi) a plurality of websites,
(b) at least one of: (I) each advantage of the plurality of advantages, (II) at least one of the each advantage of the plurality of advantages, (III) each of the at least one promotional offer, and (IV) at least one of the at least one promotional offer, is at least one of: (i) associated with a product, (ii) associated with a service, (iii) associated with a shop, (iv) associated with a website, (v) associated with a category of products, (vi) associated with a category of services, (vii) associated with a category of shops, (viii) associated with a category of websites, (ix) associated with a plurality of products, (x) associated with a plurality of services, (xi) associated with a plurality of shops, and (xii) associated with a plurality of websites,
(c) each advantage of the plurality of advantages is the same or different, and
(d) at least two of the each advantage of the plurality of advantages are the same or different.

45. The system of claim 35, wherein at least one of:
(a) at least one of: (i) the first determination, (ii) the second determination, and (iii) the third determination, is true or false,
(b) the second or third determination is an instant determination,
(c) the third determination is based at least on at least one of: (i) a ranking, (ii) random, (iii) skill, (iv) skill with a part of chance, (v) time, (vi) the moment of the request, (vii) points, (viii) a number of points, (ix) fidelity, (x) individual criteria, (xi) name, (xii) birth, (xiii) money, (xiv) fortune, (xv) revenue, (xvi) an event, (xvii) the outcome of an event, (xviii) knowledge, and (xix) a game,
(d) the third determination is at least one of: (i) done at the end of the at least one period of the plurality of periods, (ii) done during the at least one period of the plurality of periods, and (iii) done at the end of the plurality of periods,
(e) at least one of: (I) the third determination is based at least on a number of points, (II) the third determination is based at least on the moment of the request, (III) the third determination is done at the end of the at least one period of the plurality of periods, (IV) the third determination is done during the at least one period of the plurality of periods, (V) the third determination is done at the end of the plurality of periods, (VI) the third determination is based at least on a ranking, and (VII) the third determination is based at least on time, and at least one of: (i) the at least one user is provided with zero available advantage, (ii) the at least one user is provided with one available advantage, (iii) the at least one user is provided with more than one available advantage, (iv) zero available advantage is provided, (v) one available advantage is provided, (vi) more than one available advantage is provided, and (vii) at least two users are provided with at least one available advantage, and
(f) the third determination is based at least on at least one number of points wherein the calculation of the at least one number of points comprise at least one of: (i) points granted in at least one game, (ii) points granted for fidelity, (iii) points associated with the at least one request, and (iv) points associated with the at least one request and points granted in at least one game.

46. The system of claim 35, further comprising at least one of:
(a) the at least one promotional offer is associated with at least one game, wherein the third determination to determine if the request is associated with the at least one available advantage is based at least on the at least one game, and wherein at least one of: (i) the at least one game is a game of pure chance, (ii) the at least one game has a part of chance, (iii) the at least one game is a game of mixed chance and skill, (iv) the at least one game is a lottery game, (v) the at least one game is a forecasting game, (vi) the at least one game is a financial game, (vii) the at least one game is a financial forecasting game, (viii) the at least one game is a betting game, (ix) the at least one game is a sports game, (x) the at least one game is a game with questions, (xi) the at least one game is a quizz, (xii) the at least game is a skill game, (xiii) the at least game has a part of skill, (xiv) the at least game is a game of knowledge, and (xv) the at least game has a part of knowledge, and
(b) the at least one promotional offer is associated with at least one event, wherein the third determination to determine if the request is associated with the at least one available advantage is based at least on the outcome of the at least one event, and the at least one event is at least one of: (i) an event associated with the at least one user, (ii) an event associated with a shop, (iii) an event associated with money, (iv) an event associated with a number, (v) an event associated with a result, and (vi) an event associated with sports.

47. The system of claim 35, further comprising at least one of:
(a) receive at least one second payment from at least one other source than the at least one user, wherein the at least one second payment is associated with: (i) advertising, (ii) selling data, (iii) sponsoring, (iv) selling a service, (v) selling a product, (vi) at least one device, (vii) at least one mobile device, and (viii) at least one investor,
(b) build databases with collected data,
(c) sell data associated with the at least one user,
(d) after the second determination use links to websites or mobile sites, and
(e) use links to websites or mobile sites.

48. The system of claim 35, wherein the at least one user is located in a determined shop when he makes the request and at least one of:
(a) the at least one category comprises items sold in the determined shop,
(b) the at least one category is at least one of: (i) a product, (ii) a service, (iii) a shop, (iv) a website, (v) a category of products, (vi) a category of services, (vii) a category of shops, (viii) a category of websites, (ix) including at least one product, (x) including at least one service, (xi) including at least one shop, (xii) including at least one website, (xiii) a plurality of products, (xiv) a plurality of services, (xv) a plurality of shops, and (xvi) a plurality of websites, and
(c) at least one of: (I) each advantage of the plurality of advantages, (II) at least one of the each advantage of the plurality of advantages, (III) each of the at least one promotional offer, and (IV) at least one of the at least one promotional offer, is at least one of: (i) associated with a product, (ii) associated with a service, (iii) associated with a shop, (iv) associated with a website, (v) associated with a category of products, (vi) associated with a category of services, (vii) associated with a category of shops, (viii) associated with a category of websites, (ix) associated with a plurality of products, (x) associated with a plurality of services, (xi) associated with a plurality of shops, and (xii) associated with a plurality of websites.

49. The system of claim 35, further comprising: causing a processor to execute a plurality of instructions stored on at least one memory device to:
(a) determine a time in the at least one period of the plurality of periods, and
(b) if the time is determined in the at least one period of the plurality of periods:
(i) cancel the third determination,
(ii) if the second determination is true, make a fourth determination wherein the fourth determination is to determine if:
(iia) the request is associated with the at least one available advantage, and
(iib) the request is received after the determined time in the at least one period of the plurality of periods, and
(iii) if the fourth determination is true, provide the at least one available advantage to the at least one user.

50. The system of claim 35, further comprising:
(a) determine at least one supplier wherein the at least one supplier is associate with the at least one category, and
(b) contact at least one of each of the at least one supplier associated with the at least one category wherein at least one of:
(i) at least one of each of the at least one supplier associated with the at least one category is invited to make a business offer to the at least one user,
(ii) at least one of each of the at least one supplier associated with the at least one category is invited to make a business offer to the at least one user wherein the business offer to the at least one user is associated with a quantity,
(iii) at least one of each of the at least one supplier associated with the at least one category makes a business transaction with the at least one user,
(iv) at least one of each of the at least one supplier associated with the at least one category makes a business transaction with the at least one user wherein the business transaction with the at least one user is associated with a quantity, and
(v) at least one of each of the at least one supplier associated with the at least one category is invited to use collected data from the at least one user.

51. The system of claim 35, further comprising:
(a) include in at least one of the at least one promotional offer a plurality of items to be sold, said the plurality of items, wherein:
(i) the plurality of items is associated with the plurality of advantages included in the at least one of the at least one promotional offer,
(ii) each of the items of the plurality of items is at least one of: (iia) a product, (iib) a service, (iic) a plurality of products, (iid) a plurality of services, and (iie) a plurality of products and services,
(iii) each item of the plurality of items is associated with each advantage of the plurality of advantages included in the at least one of the at least one promotional offer, and
(b) if the third determination is true:
(i) determine if the at least one available advantage is associated with the at least one of the at least one promotional offer,
(ii) if the determination is that the at least one available advantage is associated with the at least one of the at least one promotional offer, determine the item of the plurality of items which is associated with the at least one available advantage, said the promoted item, and
(iii) if the at least one available advantage is provided to the at least one user, sell the promoted item to the at least one user.
